(19) United States
(12) Patent Application Publication
(10) Pub. No.: US 2016/0364268 A1
(43) Pub. Date: Dec. 15, 2016

(54) COMPUTER SYSTEM, MANAGEMENT COMPUTER, AND MANAGEMENT METHOD

(71) Applicant: HITACHI, LTD., Tokyo (JP)

(72) Inventors: Wataru OKADA, Tokyo (JP); Nobuhiro MAKI, Tokyo (JP)

(73) Assignee: HITACHI, LTD., Tokyo (JP)

(21) Appl. No.: 15/120,806

(22) PCT Filed: Jun. 26, 2014
(86) PCT No.: PCT/JP2014/066963

§ 371 Date: Aug. 23, 2016

(51) Int. Cl. G06F 9/50; G06F 13/10

(52) U.S. Cl. CPC G06F 9/5011; G06F 13/102

(57) ABSTRACT

A management computer is configured to: receive indication information which indicates creating a logical partition and which includes information on performance for processing an input/output instruction required by the logical partition to be created; identify a computer resource newly allocatable to a logical partition in each of a plurality of physical storage apparatuses; and issue, when there is no physical storage apparatus capable of independently creating the logical partition, to the plurality of physical storage apparatuses an indication to create a logical partition which straddles a plurality of physical storage apparatuses and to which a computer resource for satisfying the performance for processing an input/output instruction and a computer resource for transferring an input/output instruction among the physical storage apparatuses are allocated.

### TECHNICAL FIELD

The present invention relates to a technique for managing resources in a computer system including a plurality of physical storage apparatuses.

### BACKGROUND ART

In a computer system in which a plurality of physical storage apparatuses are coupled to each other via a network, a volume identifier management method is used which provides a host computer and a management computer with a plurality of logical volumes of the plurality of physical storage apparatuses as a logical volume of a single virtual storage apparatus (for example, refer to PTL 1).

Meanwhile, recently, in a large-scale storage consolidation environment in which physical storage apparatuses are shared and used by a plurality of companies, a plurality of departments, or the like in order to reduce a burden on a storage manager, there is a need for a multi-tenancy type management method as a storage management method in which a manager is stationed at each company or each department and a physical storage resource is distributed to each manager. In such an environment, for example, a resource configuration management method which divides a physical storage resource into a plurality of logical partitions is used.

In consideration of the technological trends described above, in the future, a logical partitioning technique may conceivably be applied to a virtual storage apparatus constituted by a plurality of physical storage apparatuses. In this case, as a method of guaranteeing performance suitable for a resource allocated to each logical partition, a method is adopted in which a logical partition is configured from a single physical storage apparatus so as not to straddle physical storage apparatuses (refer to PTL 2).

### CITATION LIST

### Patent Literature

### [PTL 1]

### US Patent Application Publication No. 2008/0034005 (Specification)

### [PTL 2]

### US Patent Application Publication No. 2006/0224854 (Specification)

### SUMMARY OF INVENTION

### Technical Problem

In a recent utilization mode of a multi-tenancy type storage apparatus referred to as a cloud, logical partitions are frequently created, deleted, expanded, and contracted. In such an environment, there is no guarantee that a logical partition can be created from a single physical storage apparatus. The prior art described above do not disclose a method of guaranteeing performance in a case where a logical partition straddles a plurality of physical storage apparatuses. Therefore, even if there is a sufficient surplus of resources in a virtual storage apparatus as a whole, a logical partition of which performance is guaranteed cannot always be provided.

An object of the present invention is to provide a logical partition of which performance is guaranteed in an efficient manner from a virtual storage apparatus including a plurality of physical storage apparatuses.

### Solution to Problem

A computer system according to an aspect of the present invention is a computer system including a plurality of physical storage apparatuses, one or more host computers coupled to the physical storage apparatuses, and a management computer configured to manage the physical storage apparatuses, wherein the physical storage apparatuses include an input/output transfer function for transferring an input/output instruction received from the host computer to another physical storage apparatus, and a logical partition control function for allocating a computer resource to one or more logical partitions and determining which logical partition's computer resource is to be used by an input/output instruction received from the host computer, and moreover processing the input/output instruction with the logical partition's computer resource determined to be used, and the management computer is configured to: receive indication information which indicates creation of a logical partition and which includes information on performance for processing an input/output instruction required by the logical partition to be created, identify a computer resource newly allocatable to a logical partition in each of the physical storage apparatuses, determining whether or not there is a physical storage apparatus capable of independently creating a logical partition satisfying the performance for processing the input/output instruction, based on the identified computer resource allocatable to the logical partition, issue, when there is a physical storage apparatus capable of independently creating the logical partition, to the physical storage apparatus an indication to create the logical partition to which the computer resource for satisfying performance for processing the input/output instruction is allocated, and issue, when there is no physical storage apparatus capable of independently creating the logical partition, to the plurality of physical storage apparatuses an indication to create a logical partition which straddles a plurality of physical storage apparatuses and to which a computer resource for satisfying performance for processing the input/output instruction and a computer resource for transferring an input/output instruction among physical storage apparatuses are allocated.

### Advantageous Effects of Invention

According to an embodiment of the present invention, a logical partition of which performance is guaranteed can be provided in an efficient manner from a virtual storage apparatus including a plurality of physical storage apparatuses.

### BRIEF DESCRIPTION OF DRAWINGS

FIG. 1A is a diagram for illustrating an outline of a present embodiment.

FIG. 1B is a diagram for illustrating an outline of the present embodiment.

FIG. 2 is a block diagram showing a configuration example of a computer system according to example 1.

FIG. 3 is a block diagram showing a configuration of a physical storage apparatus 1200.

FIG. 4 is a resource management table that constitutes logical partition configuration management information 1442.

FIG. 5 is an inter-enclosure coupling table that constitutes logical partition configuration management information 1442.

FIG. 6 is a necessary resource management table per input/output unit performance that constitutes logical partition configuration management information 1442.

FIG. 7 is a necessary resource management table per unit performance of input/output transfer that constitutes logical partition configuration management information 1442.

FIG. 8 is a logical partition allocation information table that constitutes logical partition configuration management information 1442.

FIG. 9 is a resource allocation information table for coupling plurality of physical storages that constitutes logical partition configuration management information 1442.

FIG. 10 is an intra-apparatus logical partition allocation information table that constitutes logical partition information 1236.

FIG. 11 is an allocation information table for coupling plurality of physical storages that constitutes logical partition information 1236.

FIG. 12 is a flow chart showing a process of creating a logical partition by a logical partition configuration program 1441.

FIG. 13 is a flow chart showing a process of calculating a necessary resource for each physical storage apparatus which is performed during a logical partition creation flow.

FIG. 14 is a flow chart showing a process of calculating a necessary resource when creating a logical partition by input/output transfer between a plurality of physical storage apparatuses which is performed during a logical partition creation flow.

FIG. 15 is a flow chart showing a process of expanding a logical partition by the logical partition configuration program 1441.

FIG. 16 is a flow chart showing a process of contracting a logical partition by the logical partition configuration program 1441.

FIG. 17 is a flow chart showing a process of deleting a logical partition by the logical partition configuration program 1441.

FIG. 18 is a block diagram showing a configuration example of a computer system according to example 2.

FIG. 19 is a necessary resource management table per unit performance of migration that constitutes logical partition configuration management information 1442.

FIG. 20 is a flow chart showing a process of creating a logical partition by the logical partition configuration program 1441.

FIG. 21 is a flow chart showing a flow of a process of creating an internal logical partition by the logical partition configuration program 1441.

FIG. 22 is a backup resource allocation information table in the physical storage apparatus 1200 which constitutes logical partition configuration management information 1442.

FIG. 23 is a flow chart showing a flow of a process of creating a logical partition by the logical partition configuration program 1441.

### DESCRIPTION OF EMBODIMENTS

Hereinafter, an embodiment of the present invention and examples thereof will be described with reference to the drawings.

The embodiment described herein is for illustrating features of the present invention and is not intended to limit the present invention. While the present embodiment is described in sufficient detail for those skilled in the art to implement the present invention, it is to be understood that other implementations and modes are possible and that modifications of the configurations and structures and replacing of various elements can be performed without departing from the scope and spirit of the technical ideas of the present invention.

Therefore, the following description should not be interpreted as being limited thereto. A component of a certain embodiment or a certain example can be added to another embodiment or an example or be replaced with a component of another embodiment or an example without departing from the scope of the technical ideas of the present invention. As will be described later, embodiments of the present invention may be implemented by software running on a generic computer, dedicated hardware, or a combination of software and hardware.

Moreover, while information utilized in the present embodiment will be hereinafter described mainly using a “table” format, the information need not necessarily be expressed by a data structure using a table and may be expressed by data structures such as a list, a DB (database), and a queue or by other forms.

Hereinafter, when describing each process in the embodiment using a “program” as a subject (operating entity), the program causes prescribed processing to be performed using a memory and a communication port (a communication control apparatus) by being executed by a processor. As such, a “processor” may be considered a subject in the following description.

In addition, a process disclosed using a program as a subject may be considered a process performed by a computer such as a management computer or by a storage system. A part of or all of a program may be realized by dedicated hardware or may be modularized.

Information such as a program, a table, and a file which realizes respective functions can be stored in a storage device such as a non-volatile semiconductor memory, a hard disk drive, and an SSD (solid state drive) or a computer-readable non-transitory data storage medium such as an IC card, an SD card, and a DVD, and can be installed in a computer or a computer system by means of a program distribution server or a non-transitory storage medium.

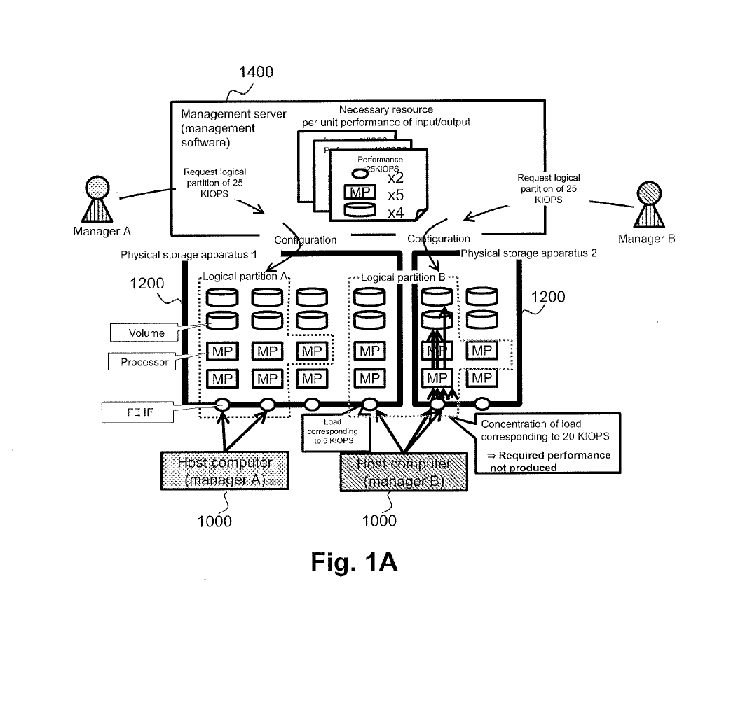

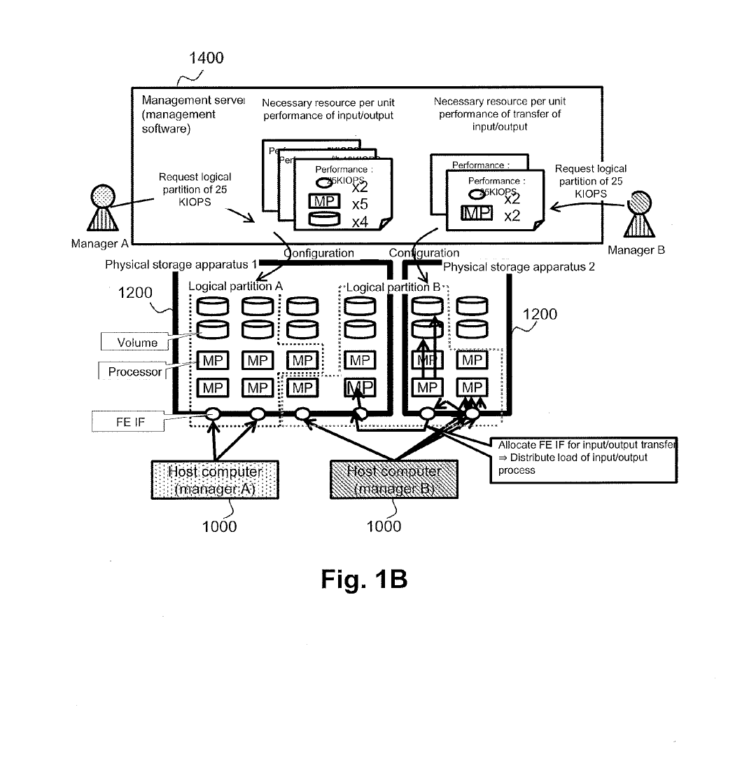

FIG. 1A and FIG. 1B are diagrams for illustrating an outline of the present embodiment.

Referring to FIGS. 1A and 1B, a computer system according to the present embodiment includes a host computer 1000, a physical storage apparatus 1200, and a management server 1400. One or more host computers 1000 exist and the physical storage apparatus 1200 exists in plurality. The host computer 1000 is coupled to the physical storage apparatus 1200. The management server (management computer) 1400 manages the physical storage apparatus 1200.

The physical storage apparatus 1200 has an input/output transfer function and a logical partition control function. The input/output transfer function is a function for transferring an input/output instruction the physical storage apparatus 1200 received from the host computer 1000 to another physical storage apparatus 1200. The logical partition control function is a function for allocating a computer resource (a resource) to one or more logical partitions, determining which logical partition's computer resource is to be used by an input/output instruction received from the host computer 1000, and processing the input/output instruction with the logical partition's computer resource determined to be used.

When the management server 1400 receives indication information which indicates creation of a logical partition and which includes information on performance for processing an input/output instruction required by the logical partition to be created, the management server 1400 executes the following processes.

First, the management server 1400 identifies a computer resource newly allocatable to a logical partition in each of the physical storage apparatuses 1200. In addition, based on the identified computer resource allocatable to a logical partition, the management server 1400 determines whether or not there is a physical storage apparatus 1200 capable of independently creating a logical partition satisfying performance for processing the input/output instruction. When there is a physical storage apparatus 1200 capable of independently creating the logical partition, the management server 1400 indicates creation of the logical partition to which the computer resource for satisfying performance for processing the input/output instruction is allocated, in the physical storage apparatus 1200. On the other hand, when there is no physical storage apparatus 1200 capable of independently creating the logical partition, the management server 1400 indicates creation of a logical partition which straddles a plurality of physical storage apparatuses 1200 and to which a computer resource for satisfying performance for processing the input/output instruction and a computer resource for transferring an input/output instruction among physical storage apparatuses 1200 are allocated in the plurality of physical storage apparatuses 1200.

According to the present embodiment, when creating a logical partition, if performance required by the logical partition can be satisfied by an independent physical storage apparatus 1200, the logical partition is created in an independent physical storage 1200, but if the required performance cannot be satisfied by an independent physical storage apparatus 1200, a logical partition to which necessary computer resources including that required to transfer an input/output instruction between physical storages is created so as to straddle a plurality of physical storage apparatuses 1200. Therefore, a logical partition of which performance is guaranteed can be provided in an efficient manner by a virtual storage system including a plurality of physical storage apparatuses 1200.

FIG. 1A shows a manager A and a manager B respectively attempting to create a logical partition having performance of 25 KIOPS. Management software running on the management server 1400 which configures logical partitions manages information on resources necessary for realizing certain performance with respect to an input/output instruction. The example in FIG. 1A shows that two FE IFs (front end interfaces), five MPs (microprocessors), and four volumes are necessary as resources for realizing performance of 25 KIOPS (IOPS: units of input/output performance).

The management server 1400 manages a physical storage apparatus (1) 1200 and a physical storage apparatus (2) 1200 and creates logical partitions from the two physical storage apparatuses 1200.

The physical storage apparatus (1) 1200 includes four FE IFs, eight MPs, and eight volumes. The physical storage apparatus (2) 1200 includes two FE IFs, four MPs, and four volumes.

With respect to a first request from the manager A to create a logical partition, all resources from the physical storage apparatus (1) 1200 are allocated. However, with respect to a second request from the manager B, neither of the physical storages (1, 2) 1200 enable necessary resources to be allocated from a single storage apparatus. Assuming that a logical partition is configured so as to straddle physical storage apparatuses 1200 and that the input/output transfer function is not used, when requests for input/output processes concentrate on one physical storage apparatus 1200, required performance cannot be produced.

In consideration thereof, in the present embodiment, the physical storage apparatuses 1200 are provided with the input/output transfer function as described above. In addition, as shown in FIG. 1B, the management server 1400 manages information on resources per unit performance considered necessary to transfer an input/output instruction. Furthermore, when it is necessary to create a logical partition that straddles physical storage apparatuses 1200, the management server 1400 allocates resources to the logical partition including resources necessary for transferring the input/output instruction. Accordingly, a load of input and output is balanced among the plurality of physical storage apparatuses 1200 and a logical partition can be configured so as to satisfy required performance.

### Example 1

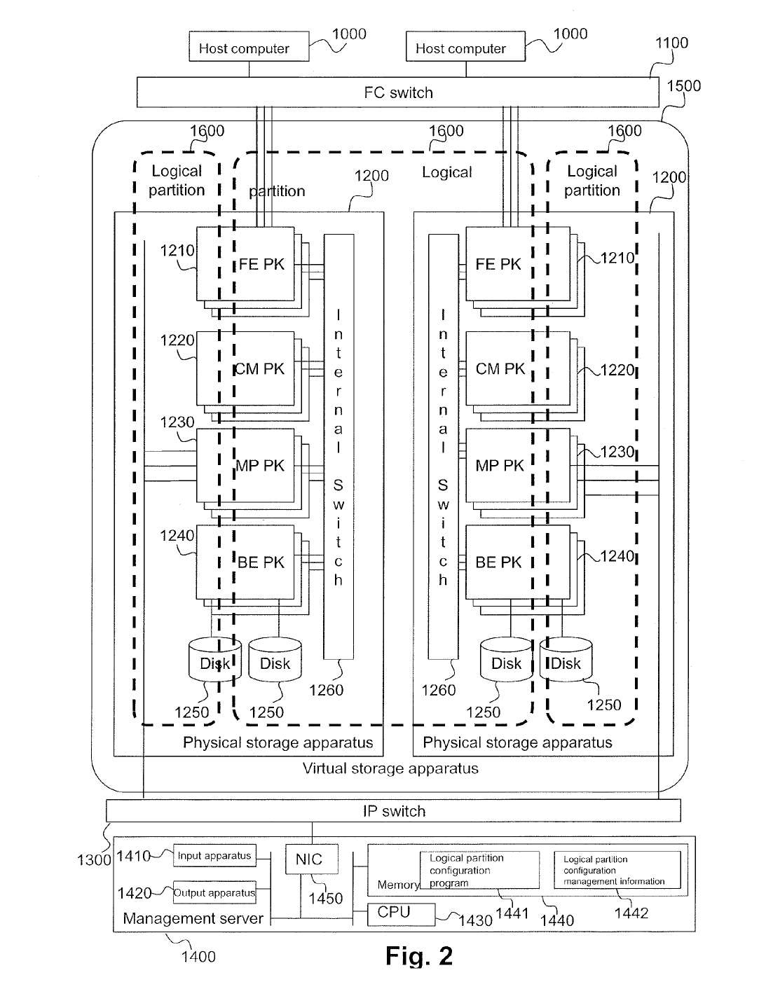

FIG. 2 is a block diagram showing a configuration example of a computer system according to the present example.

The computer system is constituted by a host computer 1000, an FC switch 1100, a physical storage apparatus 1200, an IP (Internet protocol) switch 1300, and a management server 1400.

The host computer 1000 may be a general server or a server with a virtualization function. In the case of a general server, an OS (operating system) and applications (a DB, a file system, and the like) running on the host computer 1000 are to perform input and output of data with respect to a storage area provided by the physical storage 1200. In addition, in the case of a server with a virtualization function, the virtualization function or an application on a VM (virtual machine) provided by the virtualization function is to perform input and output of data with respect to a storage area provided by the physical storage apparatus 1200.

The host computer 1000 and the physical storage apparatus 1200 are coupled to each other by an FC (Fiber Channel) cable. Using the coupling, the host computer 1000 or the VM provided by the host computer 1000 performs input and output of data with respect to a storage area provided by the physical storage apparatus 1200.

Moreover, while the host computer 1000 and the physical storage apparatus 1200 may be directly coupled to each other, coupling via the FC switch 1100 enables a plurality of host computers 1000 or a plurality of physical storage apparatuses 1200 to be coupled. Furthermore, by coupling FC switches 1100 to each other, a larger number of host computers 1000 and physical storage apparatuses 1200 can be coupled.

In addition, while the host computer 1000 and the physical storage apparatus 1200 are coupled by an FC cable in the present example, the host computer 1000 and the physical storage apparatus 1200 may be coupled by an Ethernet cable (Ethernet is a registered trademark) when a protocol such as iSCSI is used or may be coupled by other coupling schemes that can be used to input and output data. In this case, an IP switch or a device having a switching function suitable for another coupling scheme is to be used in place of the FC switch 1100.

The management server 1400 is a server for managing the physical storage apparatus 1200.

In order to manage the physical storage 1200, the management server 1400 is coupled to the physical storage apparatus 1200 by an Ethernet cable.

Moreover, while the management server 1400 and the physical storage apparatus 1200 may be directly coupled to each other, coupling via the IP switch 1300 enables a plurality of management servers 1400 or a plurality of physical storage apparatuses 1200 to be coupled. Furthermore, by coupling IP switches 1300 to each other, a larger number of management servers 1400 and physical storage apparatuses 1200 can be coupled.

While the management server 1400 and the physical storage apparatus 1200 are coupled to each other by an Ethernet cable in the present example, the management server 1400 and the physical storage apparatus 1200 may be coupled by other coupling schemes that enable data transmission and reception for management. In this case, a device having a switching function suitable for the used coupling scheme is to be used in place of the IP switch 1300.

While the physical storage apparatus 1200 is coupled to the host computer 1000 by an FC cable as described earlier, the physical storage apparatus 1200 is also coupled to other physical storage apparatuses 1200.

The physical storage apparatus 1200 and the management server 1400 according to the present example have functions to virtually provide a user using the host computer 1000 or the management server 1400 with a plurality of physical storage apparatuses 1200 as one or more virtual storage apparatuses 1500. In addition, the physical storage apparatus 1200 and the management server 1400 according to the present example have functions to logically divide one virtual storage apparatus 1500 and provide a user using the host computer 1000 or the management server 1400 with the logically-divided virtual storage apparatus 1500 as a plurality of logical partitions 1600.

Moreover, as another embodiment that differs from the present example, an aspect may be adopted which does not include a concept of the virtual storage apparatus 1500, in which case the management server 1400 manages one or more physical storage apparatuses 1200 as a pool and creates a logical partition 1600 from the pool. Since the present invention can be similarly applied to both schemes, hereinafter, a case including a concept of the virtual storage apparatus 1500 will be described as an example.

An internal configuration of the physical storage apparatus 1200 will be described later.

The management server 1400 is constituted by an input apparatus 1410, an output apparatus 1420, a CPU (central processing unit) 1430, a memory 1440, and an NIC (network interface card) 1450.

The input apparatus 1410 is a keyboard, a mouse, a tablet, a stylus, or the like.

The output apparatus 1420 is a display, a printer, a speaker, or the like.

The CPU 1430 is a processor for executing various programs stored in the memory 1440.

The memory 1440 is a data storage area of a RAM (random access memory) or the like and stores various programs, data, or temporary data. In particular, in the present example, a logical partition configuration program 1441 and logical partition configuration management information 1442 are stored in the memory 1440.

The NIC 1450 is an interface (I/F) card to which the Ethernet cable is to be coupled. When a network other than an IP network is used, the NIC 1450 is to be replaced with an I/F card suitable for the used network.

Operations of the CPU 1430 by the logical partition configuration program 1441 will be described later.

Moreover, the numbers of the host computer 1000, the FC switch 1100, the physical storage apparatus 1200, the IP switch 1300, and the management server 1400 are not limited to the numbers shown in the present diagram and may be any number equal to or larger than one.

In addition, the management server 1400 may be stored in a physical storage.

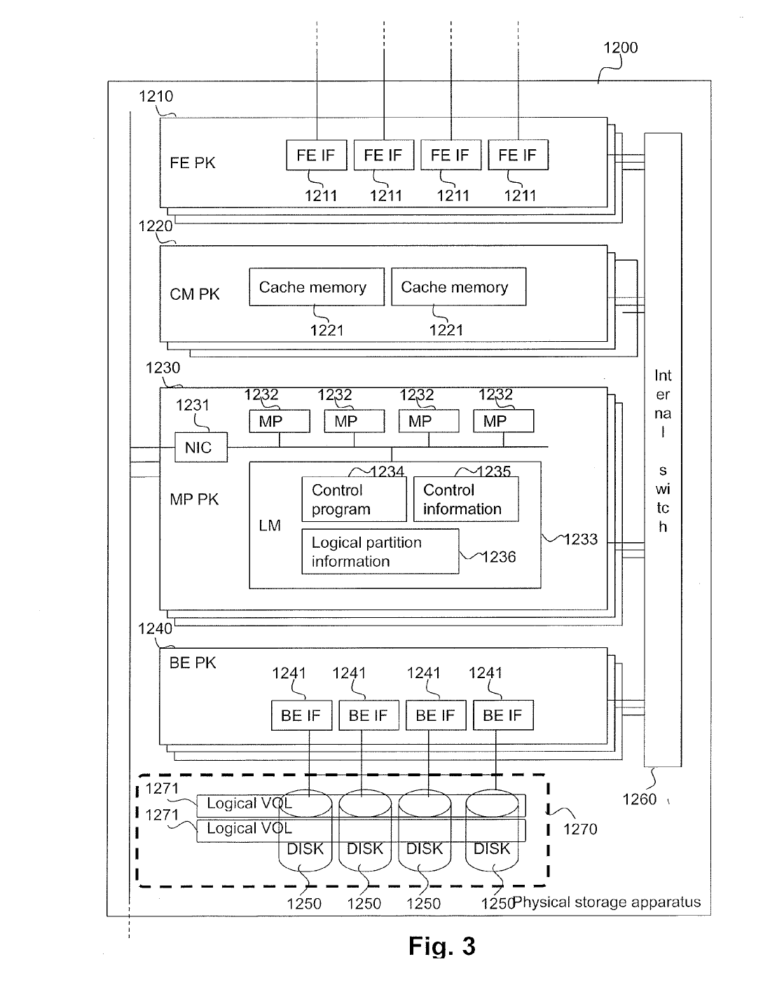

FIG. 3 is a block diagram showing a configuration of the physical storage apparatus 1200.

The physical storage apparatus 1200 is constituted by an FE PK (PK denotes package) 1210, a CM PK 1220, an MP PK 1230, a BE PK 1240, a disk drive 1250, and an internal switch 1260.

The FE PK 1210, the CM PK 1220, the MP PK 1230, and the BE PK 1240 are coupled to each other by a high-speed internal bus or the like. As an example, the coupling is realized via the internal switch 1260.

The FE PK 1210 includes one or more FE IFs 1211 which are interfaces for data input and output and is coupled to the host computer 1000, other physical storage apparatuses 1200, and the FC switch 1100 via the FE IFs 1211. When data input and output are performed by communication via an FC cable, the FE PK 1210 will be in the form of an FC port. When data input and output are performed by another communication mode, an I/F suitable for the mode is provided.

The CM PK 1220 includes one or more cache memories 1221 which are storage areas that enable high-speed access such as a RAM or an SSD (solid state drive).

The cache memory 1221 stores temporary data used when the physical storage apparatus 1200 performs input and output with the host computer 1000, configuration information which enables the physical storage apparatus 1200 to carry out various functions, storage configuration information, and the like.

The MP PK 1230 is constituted by an NIC 1231, an MP 1232, and an LM (local memory) 1233.

The NIC 1231 is an interface for management and are coupled to the management server 1400 and the IP switch 1300 via the NIC 1231. When the management of the physical storage 1200 is performed by communication via an Ethernet cable, the NIC 1231 is replaced with an Ethernet port. When management is performed by another communication mode, an I/F suitable for the mode is provided.

The MP 1232 is a processor which executes a program for performing input and output with the host computer 1000 and a program of the various functions of the physical storage apparatus 1200 which are stored in the LM 1233. When the processor which executes the program for performing input and output with the host computer 1000 and the programs of the various functions of the physical storage apparatus 1200 is made up of a plurality of cores, each of the cores may be assumed to be the MP 1232.

The LM 1233 is storage area that enables high-speed access such as a RAM and stores a program for performing input and output with the host computer 1000, a control program 1234 which is a program of the various functions of the physical storage apparatus 1200, and control information 1235 thereof. In particular, in the present example, logical partition information 1236 for controlling an input/output process and various functions of storages in accordance with a configured logical partition are stored.

The numbers of the NIC 1231, the MP 1232, and the LM 1233 are not limited to the numbers shown in the present diagram and may be any number equal to or larger than one.

The BE PK 1240 includes a BE IF 1241 which is an interface enabling coupling to the disk drive 1250. While a SCSI (small computer system interface), a SATA (serial AT attachment), a SAS (serial attached SCSI), and the like are commonly adopted as the coupling mode, other coupling modes may be adopted instead.

The disk drive 1250 is a storage apparatus such as an HDD (hard disk drive), an SSD (solid state drive), a CD drive, or a DVD drive.

The numbers of the FE PK 1210, the CM PK 1220, the MP PK 1230, the BE PK 1240, the disk drive 1250, and the internal switch 1260 are not limited to the numbers shown in the present diagram and may be any number equal to or larger than one.

Functions of the control program 1234 as assumed by the present example will now be described.

The control program 1234 includes a processing program for data input and output which is provided in a general storage apparatus.

When constructing a RAID (redundant arrays of inexpensive disks) group 1270 using a plurality of disk drives 1250 and providing the host computer 1000 with a logical volume 1271 created by dividing the RAID group 1270 into one or more logical storage areas, the processing of data storage and data input and output may include a process of converting input and output with respect to the logical volume 1271 into input and output with respect to the physical disk drives 1250 and storing the converted input and output. The present example is premised on performing data input and output with respect to the logical volume.

In addition, the processing of input and output is controlled such that processing is performed using only resources allocated to each logical partition 1600 in order to avoid the effect of performance between logical partitions 1600.

For example, when performing input and output by a certain logical partition, while the control program 1234 uses processing capability of the MP 1232 as a resource, if a resource corresponding to 50% of usage of the MP 1232 is allocated to the logical partition, usage is monitored and control is performed involving sleeping the process when usage exceeds 50% and handing over the MP 1232 to processing of another logical partition 1600.

In addition, when a resource corresponding to 50% of usage of the cache memory 1221 is allocated to a certain logical partition, usage is monitored and control is performed involving releasing a part of the cache memory 1221 being used by the logical partition by destaging or the like when the usage exceeds 50% and proceeding with processing once free space is created.

While there are several conceivable methods of performing processing using only allocated resources as described above, the present invention does not specify which method is to be used. According to the present control, the physical storage apparatus 1200 need only enable processing to be performed using an allocated amount of resource without the processing of each logical partition 1600 being affected by other logical partitions 1600.

Furthermore, in order to have the host computer 1000 and the management server 1400 handle a plurality of the physical storage apparatuses 1200 as a single virtual storage apparatus 1500, for example, when the control program 1234 receives an input/output instruction to the logical volume 1271 of another physical storage apparatus 1200, the control program 1234 has a function of transferring the input/output instruction to the physical storage apparatus 1200.

When this function is provided, an ID of a volume provided by each physical storage apparatus 1200, mapping information of the FE IF 1211 of the physical storage, and the like are managed in control information 1235, and the MP 1232 transfers an instruction to the FE IF 1211 corresponding to the ID of the accessed logical volume.

While the present example assumes that the transfer of an input/output instruction (input/output transfer) is to be performed via the FE IF 1211, as another embodiment, a dedicated interface for input/output transfer may be provided. In addition, while it is assumed that the present function is to be performed by the MP 1232, as another embodiment, the present function may be performed by another dedicated hardware constituted by an ASIC (application specific integrated circuit) or the like.

Furthermore, for example, the control program 1234 has a migration function for migrating data between two physical storage apparatuses 1200. In the present function, the MP 1232 reads data of a migration source logical volume 1271 and transmits the data to the physical storage apparatus 1200 having a migration destination logical volume 1271 via the FE IF 1211. The MP 1232 of the physical storage apparatus 1200 having the migration destination logical volume 1271 receives the data of the migration source logical volume 1271 via the FE IF 1211 and writes the data to the migration destination logical volume 1271. After copying all of the data of the migration source logical volume 1271 to the migration destination in this manner, the data of the migration source logical volume 1271 is deleted. In doing so, temporary data may be stored in the cache memory 1221 in order to improve processing efficiency.

During copying, writing to an area to which copying has been completed is performed on both the migration source logical volume 1271 and the migration destination logical volume 1271 and writing to an area to which copying has not been completed is performed only on the migration source logical volume 1271.

In addition, reading during copying is performed from the migration source logical volume 1271. Once copying is completed, all reading and writing are performed on the migration destination logical volume 1271. As long as data in the migration source logical volume 1271 is maintained, the present function can also be used for remote copying in which a copy is created between different enclosures.

While these functions of the physical storage apparatus 1200 can be enhanced or simplified in various ways, since the present invention can coexist with these functions without altering its essence, the present example will be described on the premise of the functions described above.

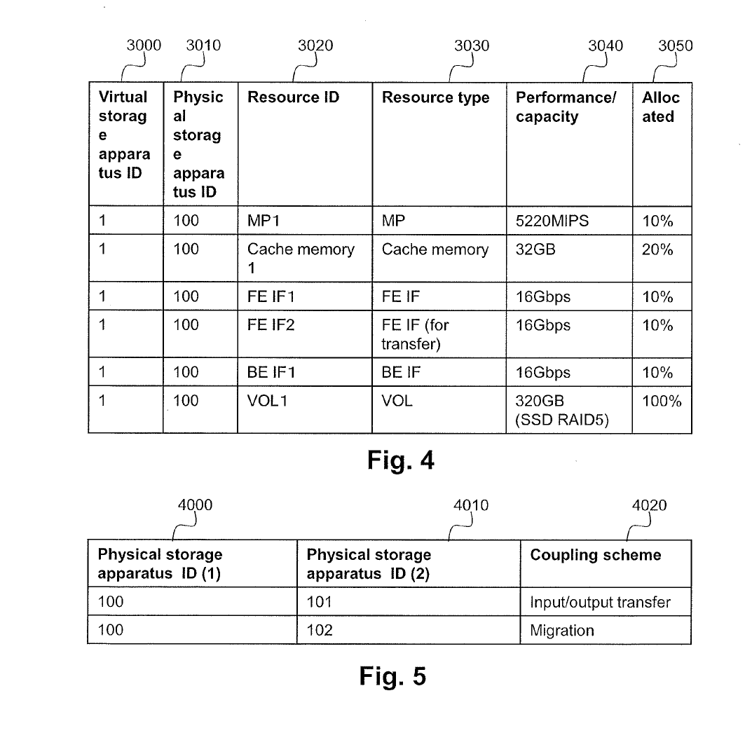

FIG. 4 is a resource management table that constitutes logical partition configuration management information 1442.

A virtual storage apparatus ID 3000 is an ID of the virtual storage apparatus 1500 in the present computer system. An ID of the physical storage apparatus 1200 belonging to the virtual storage apparatus 1500 indicated by this ID is stored in a physical storage apparatus ID 3010. An ID of a resource stored in the physical storage apparatus 1200 indicated by this ID is stored in a resource ID 3020. A character string expressing a type of the resource indicated by this ID is stored in a resource type 3030. Examples of the character string include FE IF indicating the FE IF 1211, cache memory indicating the cache memory 1221, MP indicating the MP 1232, BE IF indicating the BE IF 1241, and VOL indicating the logical volume 1271. In addition, the FE IF 1211 used for communication between physical storages is shown as FE IF (for transfer).

Performance/capacity 3040 stores performance and capacity of a resource indicated by the resource ID 3020. In the case of the FE IF 1211 or the BE IF 1241, a communicating speed (Gbps) is stored in performance/capacity 3040. In the case of the MP 1232, a processing speed (MIPS) thereof is stored. In the case of the cache memory 1221, a capacity (GB) thereof is stored. In the case of a logical volume, a capacity (GB), a disk drive type, and a RAID type thereof are stored.

When the physical storage apparatus 1200 only belongs to a single virtual storage apparatus 1500, maximum performance of each resource is stored in performance/capacity 3040. When the physical storage apparatus 1200 belongs to a plurality of virtual storage apparatuses 1500, performance or a capacity specified by the user when creating the virtual storage apparatuses 1500 is stored.

In the performance and capacity, a proportion that is already allocated to a logical partition is stored in allocated information 3050. Moreover, while an example where an allocated proportion is stored will be described in the present example, as another embodiment, absolute values of allocated performance and capacity may be presented instead.

When the physical storage apparatus 1200 includes a dedicated resource other than the resource indicated in the resource type described above for a function for transferring a data input/output instruction to another physical storage or for a migration function, the resource is also managed by the present table. For example, when a data input/output instruction is transferred by a dedicated ASIC and a dedicated IF, an ID and a processing speed (MIPS) of the ASIC, an ID and performance (Gbps) of the IF, and the like are to be managed by the present table.

The present table is configured by the logical partition configuration program 1441 upon configuration of the virtual storage apparatus 1500 based on information input by the user or information collected from the physical storage apparatus 1200.

It should be noted that the resources managed by the present table constitute a list of resources allocatable to each logical partition 1600. Therefore, if there are resources required outside of the logical partitions 1600 such as a resource necessary for control to avoid an occurrence of an effect of performance between logical partitions 1600, it should be noted that the performance and the capacity of such resources must be subtracted from performance/capacity 3040 in advance.

FIG. 5 is an inter-enclosure coupling table that constitutes logical partition configuration management information 1442.

The present table is a table showing schemes of a coupling process performed by the physical storage apparatuses 1200 in order to create a logical partition 1600 that straddles a plurality of physical storage apparatuses 1200.

A physical storage apparatus ID (1) 4000 and a physical storage apparatus ID (2) 4010 are respectively an ID which uniquely identifies the physical storage apparatus 1200 in the present computer system. A coupling scheme 4020 indicates a scheme of a coupling process between the two physical storage apparatuses 1200. Coupling schemes include input/output transfer and migration. When both schemes can be used, both schemes may be stored.

If another process for preventing the host computer 1000 from being conscious of a boundary of the physical storage apparatus 1200 in the logical partition 1600 is applied, a scheme of the process is also managed by the present table. For example, when remote copying is applied, information indicating the application of remote copying or the like may be entered in the present table.

The present table is configured by the logical partition configuration program 1441 in advance based on information input by the user or information collected from the physical storage apparatus 1200.

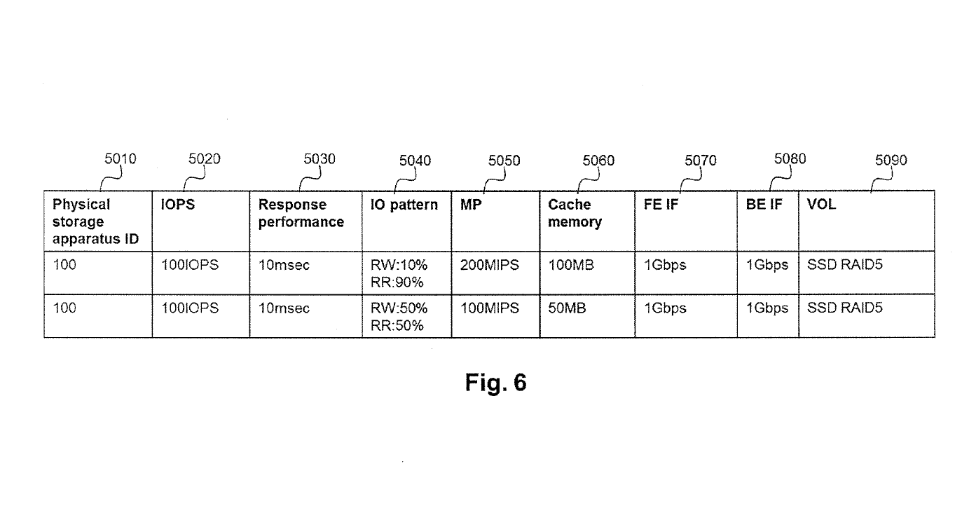

FIG. 6 is a necessary resource management table per input/output unit performance that constitutes logical partition configuration management information 1442.

The present table is a table which manages a set of resources for realizing certain performance with respect to input and output in each physical storage apparatus 1200. Hereinafter, a set of resources for realizing certain performance will be referred to as a resource set. Performance of input and output that is realized by a resource set in the present table will be referred to as unit performance of input and output.

A physical storage apparatus ID 5010 is an ID which uniquely identifies the physical storage apparatus 1200 in the present computer system. Unit performance of input and output of the physical storage apparatus 1200 indicated by this ID is stored in IOPS 5020 and response performance 5030. The IOPS 5020 indicates a processing amount of input and output per second and the response performance 5030 represents a response time per one instruction. Alternatively, throughput may be used as unit performance.

Even with a same resource set, unit performance that can be realized differs depending on input and output patterns. Therefore, as indicated by an IO pattern 5040, unit performance may be determined for each pattern of input and output such as distributions of random reads, random writes, sequential writes, and sequential reads.

In the present example, the MP 1232, the cache memory 1221, the FE IF 1211, the BE IF 1241, and the logical volume 1271 are included in a resource set. As another embodiment, when there is a resource which affects unit performance of input and output, the resource must also be managed by the present table.

An MP 5050 indicates performance (MIPS) of the MP 1232. A cache memory 5060 indicates a capacity (MB) of the cache memory 1221. An FE IF 5070 indicates a communication speed (Gbps) of the FE IF 1211.

ABE IF 5070 indicates a communication speed (Gbps) of the BE IF 1241. VOL 5090 represents a drive type and a RAID type of the logical volume 1271.

Generally, it is difficult to directly derive a required resource set from the IOPS 5020 and the response performance 5030 which represent unit performance of input and output. Therefore, in the present example, it is assumed that worst-case values of performance when input and output are executed using a specific resource set for each configured IO pattern 5040 are to be input to these values. However, a relationship between unit performance of input and output and a resource set may be derived by a scheme other than the present scheme.

Moreover, when the IO pattern 5040 has not been configured, worst-case values of performance when input and output are performed according to a prescribed input/output pattern may be used. A plurality of prescribed input/output patterns may be defined in advance. In this case, worst-case values among the worst-case values of the respective IC patterns are adopted as unit performance. A value of the IC pattern 5040 in this case is to be indicated as “N/A”.

The unit performance may be configured by the user in advance or may be obtained in advance by simulation using each physical storage apparatus 1200.

In addition, since there are cases where the larger the values of unit performance, the higher the utilization efficiency of resources, a plurality of unit performances may be defined.

Furthermore, while unit performance is configured as worst-case values in the present example as described above, as another embodiment, values subjected to various statistical processes such as average values or worst-case values from which outliers have been eliminated may be used depending on system requirements.

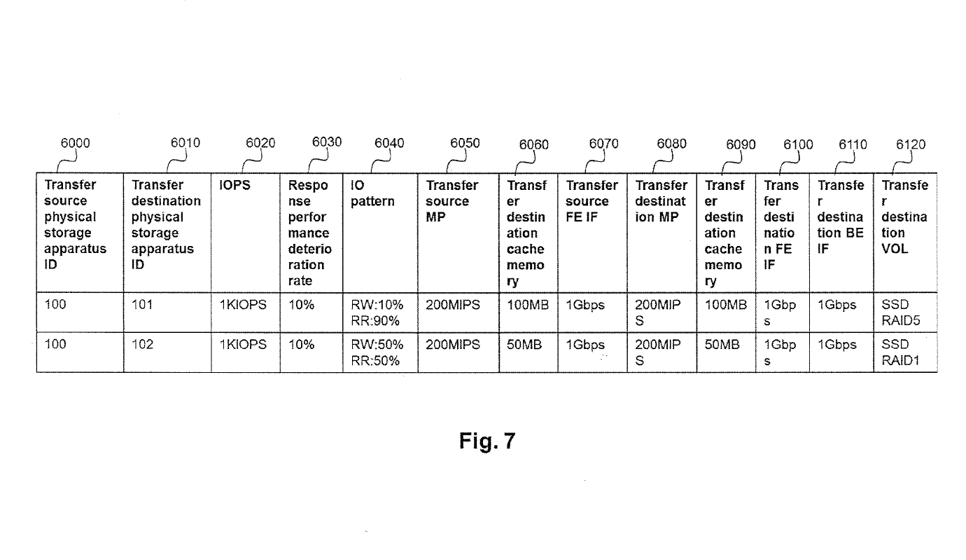

FIG. 7 is a necessary resource management table per unit performance of input/output transfer that constitutes logical partition configuration management information 1442.

The present table is a table which manages a resource set for realizing unit performance of transfer in a case where transfer of input and output is performed between physical storage apparatuses 1200.

A transfer source physical storage apparatus ID 6000 and a transfer destination physical storage apparatus 6010 are IDs that respectively uniquely identify both physical storage apparatuses 1200 which perform transfer of input and output. When an input/output instruction reaches the physical storage apparatus 1200 identified by the transfer source physical storage apparatus ID 6000, the input/output instruction is transferred to the physical storage apparatus 1200 identified by the transfer destination physical storage apparatus ID 6010.

Unit performance of transfer of input and output between the two physical storage apparatuses 1200 is stored in IOPS 6020 and response performance 6030. The unit performance of transfer of input and output is performance realized by a resource set to be described later. The input/output transfer performance 6020 indicates a processing amount of input and output per second and the response performance deterioration rate 6030 represents a deterioration rate of a response time per one instruction.

In a similar manner to unit performance of input and output, the unit performance of transfer of input and output differs depending on patterns of input and output even with a same resource set. Therefore, in a similar manner to the description given with reference to FIG. 6, unit performance may be determined for each pattern of input and output as represented by an IO pattern 6040.

In the present example, the MP 1232, the cache memory 1221, the FE IF 1211, the BE IF 1241, and the logical volume 1271 are included in a resource set. As another embodiment, when there is another resource which affects unit performance of input and output, the resource must also be managed by the present table.

A transfer source MP 6050 indicates performance (MIPS) of the MP 1232 of the physical storage apparatus 1200 that is the transfer source. A transfer source cache memory 6060 represents a capacity (GB) of the cache memory 1221 of the physical storage apparatus 1200 that is the transfer source. A transfer source FE IF 6070 represents performance (Gbps) of the FE IF 1211 of the physical storage apparatus 1200 that is the transfer source. A transfer destination MP 6080 indicates performance (MIPS) of the MP 1232 of the physical storage apparatus 1200 that is the transfer destination. A transfer destination cache memory 6090 represents a capacity (GB) of the cache memory 1221 of the physical storage apparatus 1200 that is the transfer destination. A transfer destination FE IF 6100 represents performance (Gbps) of the FE IF 1211 of the physical storage apparatus 1200 that is the transfer destination. A transfer destination BE IF 6110 represents performance (Gbps) of the BE IF 1241 of the physical storage apparatus 1200 that is the transfer destination. A transfer destination VOL 6120 represents a drive type and a RAID type of the logical volume 1271 of the physical storage apparatus 1200 that is the transfer destination.

In a similar manner to unit performance of input and output, it is difficult to directly derive a required resource set from the unit performance of transfer of input and output. Therefore, in the present example, it is assumed that worst-case values of performance when transfer of input and output is executed using a specific resource set for each configured IO pattern 6040 are to be input as these values. However, a relationship between unit performance of transfer of input and output and a resource set may be derived by a scheme other than the present scheme.

Moreover, when the IO pattern 6040 has not been configured, worst-case values in a case where input and output are performed according to a prescribed input/output pattern may be used. A plurality of prescribed input/output patterns may be defined in advance. In this case, worst-case values among the worst-case values of the respective input/output patterns are adopted as unit performance. A value of the IO pattern 6040 in this case is to be indicated as “N/A”.

The unit performance may be configured by the user in advance or may be obtained in advance by simulation using each physical storage apparatus 1200.

In addition, since there are cases where the larger the values of unit performance, the higher the utilization efficiency of resources, a plurality of unit performances may be defined.

Furthermore, while unit performance is configured as worst-case values in the present example as described above, as another embodiment, values subjected to various statistical processes such as average values or worst-case values from which outliers have been eliminated may be used depending on system requirements.

When the physical storage apparatus 1200 includes a dedicated resource for a function for transferring a data input/output instruction to another physical storage apparatus 1200, the resource is also managed by the present table. For example, when a data input/output instruction is transferred by a dedicated ASIC and a dedicated IF, usage (MIPS) of the ASIC, usage (Gbps) of the IF, and the like are to be managed by the present table.

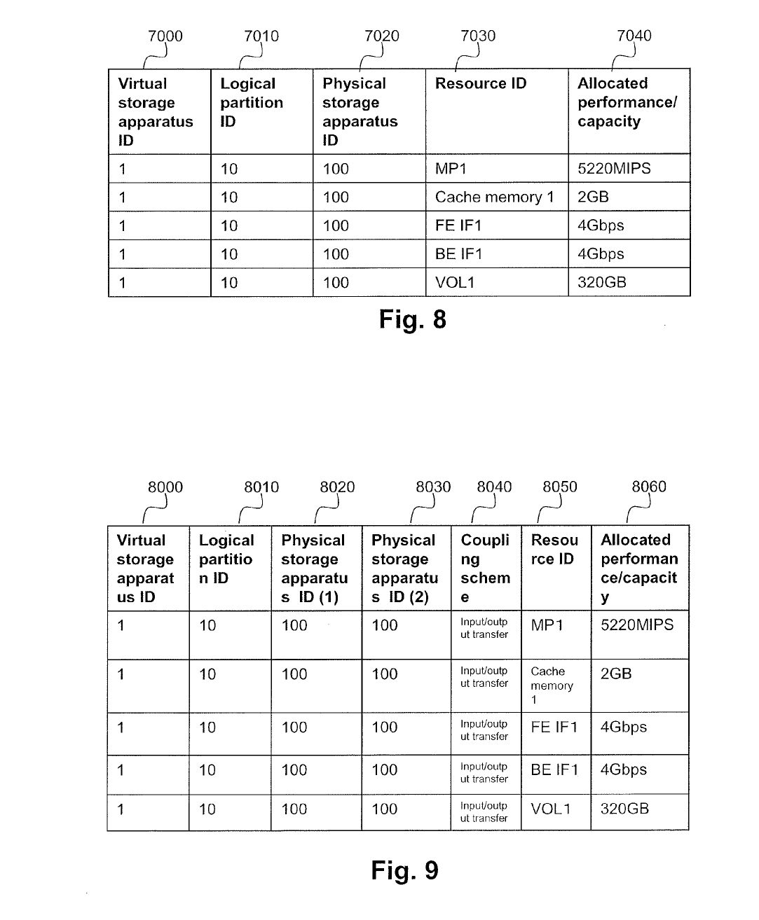

FIG. 8 is a logical partition allocation information table that constitutes logical partition configuration management information 1442.

The present table is a table which manages a resource allocated to a logical partition.

A virtual storage apparatus ID 7000 is an ID which uniquely identifies the virtual storage apparatus 1500 in the present computer system. An ID of the logical partition 1600 belonging to the virtual storage apparatus 1500 indicated by this ID is stored in a logical partition ID 7010. With respect to a resource constituting the logical partition, an ID of the physical storage apparatus 1200 to which the resource belongs is stored in a physical storage apparatus ID 7020. In addition, an ID of the resource itself is stored in a resource ID 7030. Performance and a capacity of the resource which is allocated are stored in allocated performance/capacity 7040. When the resource is the FE IF 1211 or the BE IF 1241, a communicating speed (Gbps) thereof is stored herein. In the case of the MP 1232, a processing speed (MIPS) thereof is stored. In the case of the cache memory 1221, a capacity (GB) thereof is stored. In the case of the logical volume 1271, a capacity (GB) thereof is stored.

Information in the present table is configured by the logical partition configuration program 1441 upon configuration of the logical partition 1600 based on information input by the user or information collected from the physical storage apparatus 1200.

FIG. 9 is a resource allocation information table for coupling a plurality of physical storages that constitutes logical partition configuration management information 1442.

The present table is a table which manages resources allocated in order to perform a coupling process between a plurality of the physical storage apparatuses 1200 when creating a logical partition 1600 that straddles the physical storage apparatuses 1200.

A virtual storage apparatus ID 8000 is an ID which uniquely identifies the virtual storage apparatus 1500 in the present computer system. An ID of the logical partition 1600 belonging to the virtual storage apparatus 1500 indicated by this ID is stored in a logical partition ID 8010.

A physical storage apparatus ID (1) 8020 and a physical storage apparatus ID (2) 8030 indicate that physical storage apparatuses 1200 indicated by the two IDs are being coupled with each other. A scheme used to couple these two physical storage apparatuses 1200 is stored in a coupling scheme 8040. An ID that identifies a resource allocated in order to operate the coupling scheme and performance and a capacity of the allocated resource are respectively stored in a resource ID 8050 and allocated performance/capacity 8060. When the resource is the FE IF 1211 or the BE IF 1241, a communicating speed (Gbps) thereof is stored in the performance/capacity 8060. In the case of the MP 1232, a processing speed (MIPS) thereof is stored. In the case of the cache memory 1221, a capacity (GB) thereof is stored. In the case of the logical volume 1271, a capacity (GB) thereof is stored. Moreover, when there are other resources required by various coupling schemes, such resources must also be managed herein.

Information in the present table is configured by the logical partition configuration program 1441 upon configuration of a logical partition based on information input by the user or information collected from the physical storage apparatus 1200.

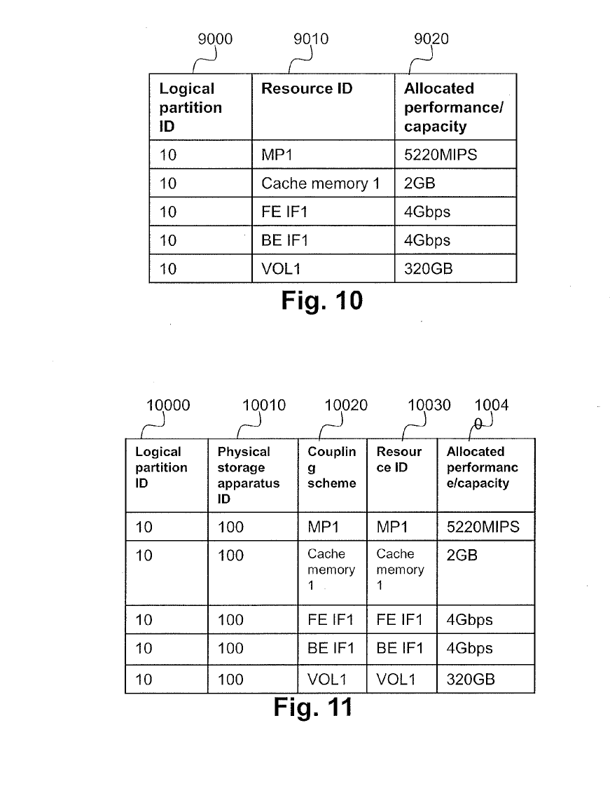

FIG. 10 is an intra-apparatus logical partition allocation information table that constitutes logical partition information 1236.

The present table is a table inside a physical storage apparatus which manages a resource allocated to a logical partition. The control program 1234 refers to the present table and calculates a resource amount that can be consumed for input and output with respect to a storage area of each logical partition 1600.

A logical partition ID 9000 is an ID which uniquely identifies the logical partition 1600 in the present computer system. An ID of a resource allocated to the logical partition 1600 indicated by this ID is stored in a resource ID 9010. In addition, performance and a capacity to which the resource is allocated are stored in allocated performance/capacity 9020. When the resource is the FE IF 1211 or the BE IF 1241, a communicating speed (Gbps) thereof is stored herein. In the case of the MP 1232, a processing speed (MIPS) thereof is stored. In the case of the cache memory 1221, a capacity (GB) thereof is stored. In the case of the logical volume 1271, a capacity (GB) thereof is stored.

Information in the present table is configured by the logical partition configuration program 1441 upon configuration of a logical partition based on information input by the user or information collected from the physical storage apparatus 1200.

FIG. 11 is an allocation information table for coupling a plurality of physical storages that constitutes logical partition information 1236.

The present table is a table which manages allocated resources when constructing a logical partition 1600 that straddles a plurality of physical storage apparatuses 1200.

The control program 1234 refers to the present table and calculates a resource amount that can be consumed for coupling with the logical partition 1600 of another physical storage apparatus 1200 with respect to a storage area of each logical partition.

A logical partition ID 10000 is an ID which uniquely identifies the logical partition 1600 in the present computer system. An ID of the physical storage apparatus 1200 coupled to the physical storage 1200 which manages the present table in the logical partition 1600 indicated by this ID is stored in a physical storage apparatus ID 10010. A coupling scheme between the physical storage apparatuses 1200 is stored in a coupling scheme 1020. An ID of a resource allocated for the coupling scheme and performance and a capacity of the resource are respectively stored in a resource ID 10030 and allocated performance/capacity 10040. When the resource is the FE IF 1211 or the BE IF 1241, a communicating speed (Gbps) thereof is stored herein. In the case of the MP 1232, a processing speed (MIPS) thereof is stored. In the case of the cache memory 1221, a capacity (GB) thereof is stored. In the case of a logical volume, a capacity (GB) thereof is stored.

Moreover, when there are other resources required by various coupling schemes, such resources must also be managed by the present table.

Information in the present table is configured by the logical partition configuration program 1441 upon configuration of a logical partition based on information input by the user or information collected from the physical storage apparatus 1200.

Next, a flow of processes of the logical partition configuration program 1441 will be described.

The logical partition configuration program 1441 includes processes for creating a logical partition, expanding a logical partition, contracting a logical partition, and deleting a logical partition.

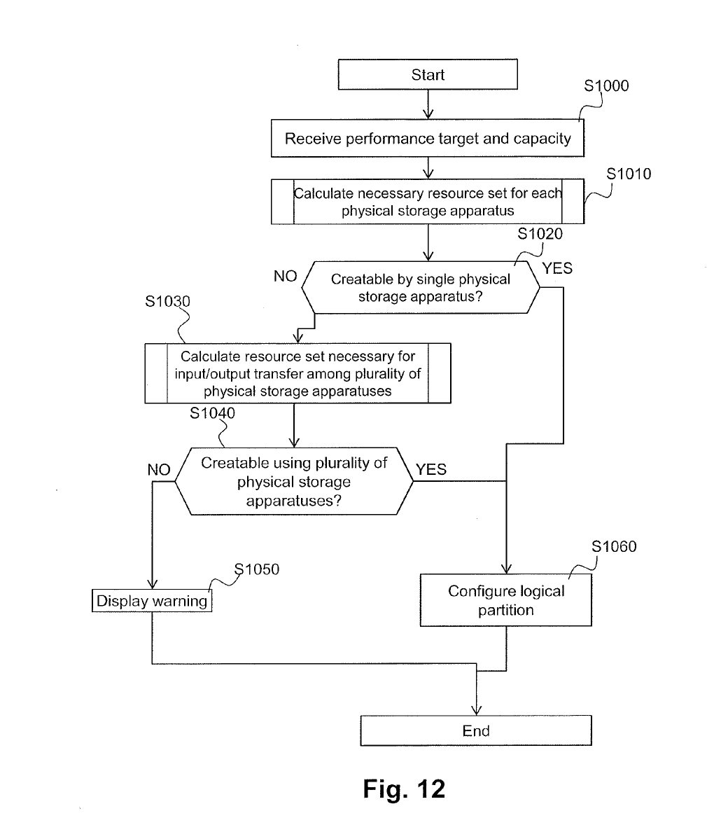

FIG. 12 is a flow chart showing a process of creating a logical partition by the logical partition configuration program 1441.

First, the CPU 1430 receives a request including, as requirements, an ID of the virtual storage apparatus 1500 to create a logical partition and a performance target and a capacity of the logical partition from the user (S1000). While an example where the performance target of the logical partition 1600 is indicated by IOPS, response performance, and an input/output pattern will be described, the performance target may further include a throughput or the like.

In addition, when only the IOPS or only the response performance is to be guaranteed, only a value thereof may be input as a requirement. Furthermore, when an input/output pattern is unknown, input of an input/output pattern may be omitted. As an input method of the input and output, a method in which values defined in the IO pattern 5040 are presented as options and the user selects one of the presented options may be adopted or a method in which the user inputs an arbitrary value may be adopted.

When an arbitrary value is input, the IO pattern 5040 that is close to the value is selected and handled. In this case, although which pattern is close may be determined by the CPU 1430 using a fixed threshold, since the threshold differs in accordance with requirements of a system using the logical partition 1600, a close pattern is desirably determined based on the user's definition. For example, a difference of less than is permissible. A case where there is no IO pattern 5040 within this permissible range is to be handled in a manner identical or similar to a case where there is no input.

The capacity represents a total capacity of a storage area allocated to the logical partition 1600.

Moreover, as a more advanced process, an application type or the like may be input instead of a performance target. In this case, the CPU 1430 is to manage a table that manages performance targets corresponding to representative applications and specifies an IOPS, response performance, and an input/output pattern using the table. For example, conceivably, in the case of a mail server, an IOPS, response performance, and an input pattern required with respect to use environments of the application including parameters such as the number of users are to be managed and an IOPS, response performance, and an input pattern are specified in accordance with user input.

Next, for each physical storage apparatus 1200 belonging to the specified virtual storage apparatus 1500, the CPU 1430 calculates a resource set for creating the logical partition 1600 in accordance with the requirements input by the user (S1010). Details of the present process will be described later.

Subsequently, the CPU 1430 determines whether or not the logical partition 1600 can be created with a single physical storage apparatus 1200 (S1020).

For each resource type of the calculated resource set, the CPU 1430 identifies a record of which the virtual storage apparatus ID 3000, the physical storage apparatus ID 3010, and the resource type 3030 in the table shown in FIG. 4 match and calculates unallocated performance and capacity from the performance/capacity 3040 and the allocated information 3050 of the record. In doing so, when there are records of a same resource type, the records are added up. When the value calculated at this point is equal to or greater than the performance and the capacity calculated in step S1010, the resource can be allocated. When each resource is allocatable, a determination can be made that resources can be allocated from the physical storage apparatus 1200. When it is found that there are one or more cases where the logical partition 1600 can be allocated from a single physical storage apparatus 1200, the process is advanced to step S1060. Otherwise, the process is advanced to step S1030.

When the logical partition 1600 cannot be created with a single physical storage apparatus 1200, the CPU 1430 calculates a resource set for creating the logical partition 1600 by straddling physical storage apparatuses 1200 (S1030). Details of the present process using a case where the logical partition 1600 is created according to a scheme of transferring input and output between physical storage apparatuses 1200 as an example will be described later.

Next, the CPU 1430 determines whether or not the logical partition 1600 can be created according to a scheme of transferring input and output between physical storage apparatuses 1200 (S1040). A determination method is similar to that of step S1020. When it is found that there are one or more cases where the logical partition 1600 is allocated, the process is advanced to step S1060. Otherwise, the process is advanced to step S1030.

In step S1050, since the CPU 1430 is unable to create the logical partition 1600, a warning is issued to the user to that effect and the process is ended.

In step S1060, it should be obvious from preceding processes whether the logical partition 1600 can be created by only a single physical storage apparatus 1200 or whether the logical partition 1600 can be created by coupling a plurality of physical storage apparatuses 1200 with each other. Even when the logical partition 1600 is to be created with a single physical storage apparatus 1200, there may be cases where there are a plurality of candidates for the physical storage apparatus 1200 to create the logical partition 1600. In this case, any one physical storage apparatus 1200 must be selected from the plurality of physical storage apparatuses 1200. In addition, even when creating the logical partition 1600 by coupling a plurality of the physical storage apparatuses 1200 with each other, there may be cases where the logical partition 1600 can be constructed in a plurality of patterns. In this case, any one of the patterns must be selected.

If creating the present logical partition 1600 results in fewer resources that can be provided when creating a next logical partition 1600 from each physical storage apparatus 1200, the possibility that the next logical partition 1600 is a logical partition that straddles physical storage apparatuses 1200 increases. With a logical partition that straddles physical storage apparatuses 1200, in order to couple the physical storage apparatuses 1200 with each other, more resources are required as compared to a case where a logical partition is created with a single physical storage apparatus 1200. Therefore, as a method of selecting the physical storage apparatus 1200 to provide a resource for creating the logical partition 1600, a policy may be adopted in which a certain physical storage apparatus 1200 which results in a minimum amount of unallocated performance and capacity is selected for creating the present logical partition 1600 and physical storage apparatuses 1200 with larger unallocated performance and capacity are saved for later.

As another policy, when expansion and/or contraction of each logical partition 1600 occur frequently, in order to prevent a logical partition 1600 from having to straddle physical storage apparatuses 1200 when the logical partition 1600 is expanded, the physical storage apparatus 1200 which results in a maximum amount of unallocated performance and capacity is selected for creating the logical partition 1600 so that sufficient performance and capacity for expanding the logical partition 1600 remain unallocated in all of the physical storage apparatuses 1200.

While these selection methods may be incorporated into the logical partition configuration program 1441, since it is conceivable that a method other than those assumed in advance may be desirably applied, the user desirably configures a selection method as a policy in accordance with system requirements. In any case, the CPU 1430 selects any one of candidates as a resource allocation method using some kind of policy.

In addition, according to the selected method, the CPU 1430 issues an indication to one or more physical storage apparatuses 1200 to create the logical partition 1600 using the calculated resource. The MP 1232 of each physical storage apparatus 1200 receives this indication, updates the table shown in FIG. 10 and the table shown in FIG. 11, and creates a new logical partition. Hereinafter, the MP 1232 executes input and output processes with respect to the created logical partition 1600 using only the allocated resource.

The CPU 1430 stores information on the created logical partition in the table shown in FIG. 8 and the table shown in FIG. 9. In addition, the CPU 1430 applies information on the allocated resource to the table shown in FIG. 4.

This concludes the description of the logical partition creation process.

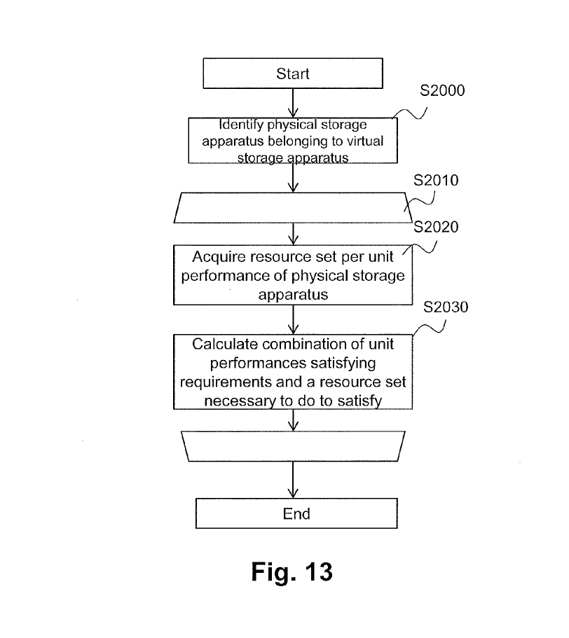

FIG. 13 is a flow chart showing a process of calculating a necessary resource for each physical storage apparatus which is performed during a logical partition creation flow.

First, the CPU 1430 identifies a record of which a value of the virtual storage apparatus ID 3000 matches an input ID of a virtual storage apparatus 1500 from the table shown in FIG. 4 and acquires a value of the physical storage apparatus ID 3010 of the record (S2000). When a plurality of physical storage apparatuses are identified in step S2000, processes of subsequent steps S2020 and S2030 are repeated for each physical storage apparatus 1200 (S2010).

The CPU 1430 identifies a resource set per unit performance of input and output of the physical storage apparatus 1200 (S2020). At this point, when an input/output pattern has been input by the user, unit performance and a resource set of a record of which the IC pattern 5040 matches the input/output pattern having been input by the user are identified. When an input/output pattern has not been input, unit performance and a resource set of a record of which the value of the IO pattern 5040 is “N/A” are identified.

Next, the CPU 1430 combines values of the IOPS 5020 and the response performance 5030 in the identified unit performance to calculate a resource set necessary to satisfy requirements input by the user (S2030). For example, a case where a performance target and a capacity received from the user includes an IOPS of 500 IOPS, response performance of 20 msec, and a capacity of 500 GB will now be considered.

Let us assume that, in the unit performance identified in step S2020, the IOPS 5020 is 100 IOPS and the response performance 5030 is 10 msec, and that the resource set for realizing this unit performance includes the MP 5050 being 200 MIPS, the cache memory 5060 being 100 MB, the FE IF 5070 being 1 Gbps, the BE IF 5080 being 1 Gbps, and the VOL 5090 being SSD RAID 5.

Due to the nature of IOPS and response performance, basically, while the IOPS increases in accordance with an amount of resources other than the VOL 5090, the response performance remains the same. In addition, while the response performance 5030 of the identified record satisfies the requirement, the IOPS only satisfies ⅕ of the requirement. This shows that five times the resource must be prepared.

Specifically, a resource set with an MP of 1000 MIPS, a cache memory of 500 MB, a FE IF of 5 Gbps, a BE IF of 5 Gbps, and an SSD RAID 5 logical volume of 500 GB is required.

While necessary resources are calculated in this manner, since there may be cases where the larger the performance requirement, the more efficiently resources may be allocated as described earlier, a plurality of unit performances and a plurality of resource sets may end up being identified for the same physical storage apparatus 1200 in step S2020. In such a case, in order to satisfy the user's requirements, a combination with a minimum allocation amount of resources using the plurality of unit performances and the plurality of resource sets must be calculated. While an optimal combination is desirably calculated by considering all possible combinations, such a calculation is well-known as a combinatorial optimization problem and is highly likely to increase an amount of calculations. In this case, an approximate solution may be obtained using an approximation algorithm.

As described above, a necessary resource set is calculated for each physical storage apparatus 1200.

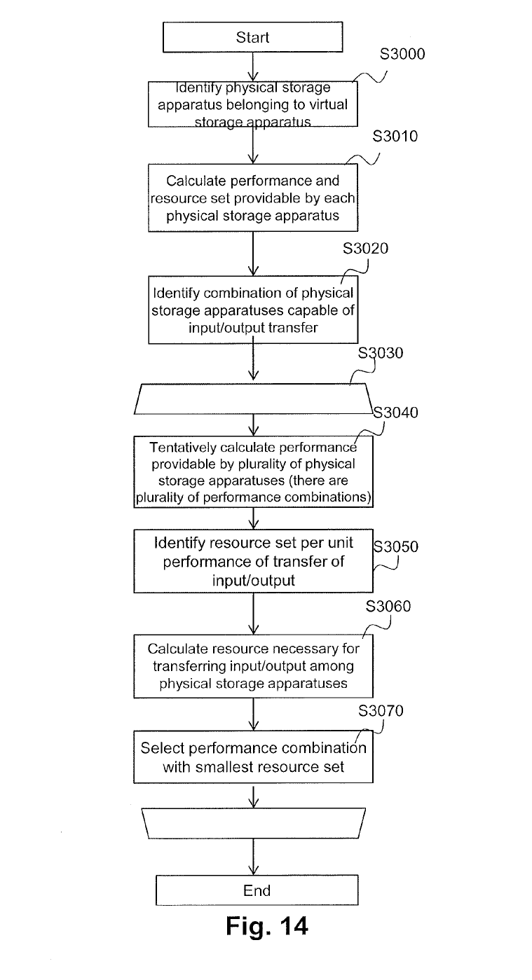

FIG. 14 is a flow chart showing a process of calculating a necessary resource when creating a logical partition by input/output transfer between a plurality of physical storage apparatuses which is performed during a logical partition creation flow.

First, the CPU 1430 identifies the physical storage apparatus 1200 belonging to the virtual storage apparatus 1500 specified by the user in a similar manner to step S2000 and identifies a resource set per unit performance which is suitable for an input/output pattern that is input by the user in each physical storage apparatus 1200 in a similar manner to step S2020 (S3000).

Subsequently, the CPU 1430 calculates a combination of performance and a resource set which can be provided by each physical storage apparatus 1200 (S3010). Specifically, first, in order to check an upper limit of performance that can be provided, the CPU 1430 refers to the allocated information 3050 in FIG. 4 and confirms unallocated performance and capacity of each resource. In addition, the CPU 1430 calculates a combination of unit performance that can be provided within the unallocated performance and capacity.

For example, let us assume that, with respect to a certain physical storage apparatus 1200, an MP has a surplus of 3000 MIPS, a cache memory has a surplus of 10 GB, an FE IF has a surplus of 2 Gbps, a BE IF has a surplus of 2 Gbps, and an SSD RAIDS has a surplus of 320 GB.

A case will now be considered where, in the physical storage apparatus 1200, unit performance including an IOPS of 100 IOPS and response performance of 10 msec is set and, in order to realize this unit performance, a resource set including an MP of 200 MIPS, a cache memory of 100 MB, an FE IF of 1 Gbps, a BE IF of 1 Gbps, and a logical volume of an SSD RAID 5 is required. In this case, combinations of unit performance that can be provided by this physical storage apparatus 1200 are (1) and (2) described below.

(1) With respect to performance including an IOPS of 100 IOPS and response performance of 10 msec, a resource set including an MP of 200 MIPS, a cache memory of 100 MB, an FE IF of 1 Gbps, a BE IF of 1 Gbps, and an SSD RAID 5 volume of 320 GB.

(2) With respect to performance including an IOPS of 200 IOPS and response performance of 10 msec, a resource set including an MP of 400 MIPS, a cache memory of 200 MB, an FE IF of 2 Gbps, a BE IF of 2 Gbps, and an SSD RAID 5 volume of 320 GB.

Moreover, performance exceeding (2) cannot be produced because only 2 Gbps remains as performance of the FE IF and the BE IF.

Next, the CPU 1430 refers to the table shown in FIG. 5 and identifies a combination of physical storage apparatuses 1200 capable of input/output transfer (S3020). In doing so, coupling of two or more physical storages may also be assumed. For example, when a physical storage apparatus A and a physical storage apparatus B are mutually capable of input/output transfer and, at the same time, the physical storage apparatus B and a physical storage apparatus C are mutually capable of input/output transfer, combinations identified in this step are the three combinations (1) to (3) described below.

(1) Physical storage apparatus A, physical storage apparatus B

(2) Physical storage apparatus B, physical storage apparatus C

(3) Physical storage apparatus A, physical storage apparatus B, physical storage apparatus C

Subsequent processes are repeated a number of times corresponding to the number of combinations calculated in step S3020 (S3030).

First, the CPU 1430 tentatively calculates performance which can be provided by the plurality of physical storage apparatuses 1200 (S3040). Since this is a tentative calculation, for an IOPS, the IOPS of the respective physical storage apparatuses 1200 is simply added and, for response performance, a worst-case value is adopted. When there are a plurality of performance patterns that can be provided, the calculation is performed for each combination. In addition, at this time point, a combination of which the IOPS or the response performance does not satisfy requirements input by the user is to be eliminated.

Next, the CPU 1430 identifies a coupling scheme for coupling the physical storage apparatuses 1200 from FIG. 5 and, in accordance with the identified coupling scheme, identifies a resource set necessary per unit performance required for each coupling from FIG. 7. An identification method is similar to that of step S2020 (S3050).

Subsequently, the CPU 1430 calculates performance and necessary resources when the plurality of physical storage apparatuses 1200 are coupled from the unit performance of input/output transfer (S3060). Moreover, unless there is an overhead due to transfer of input and output, it has been revealed by the tentative calculation in step S3040 that client requirements can be satisfied by the plurality of physical storage apparatuses 1200.

First, deterioration in response performance when input and output are transferred by each physical storage apparatus 1200 is calculated. Since deterioration is constant regardless of a resource amount, deterioration can be readily calculated from the response performance deterioration rate 6030 identified in step S3050. As a result, a combination no longer satisfying requirements of the user is eliminated from the combinations satisfying the requirements in step S3040.

Next, an IOPS of input/output transfer and a resource set which satisfy the IOPS input by the user are calculated. In the present example, a worst-case scenario in which all input and output require transfer will be assumed. In this case, an IOPS identical or similar to the IOPS provided by each physical storage apparatus 1200 must be realized by the transfer of input and output. Therefore, to this end, necessary resources for realizing the IOPS of the transfer of input and output are added up by a similar method to that performed in step S2030.

Moreover, in the present example, since unit performance and a resource set differ depending on a direction of transfer, a separate calculation is to be performed for each direction. In addition, when there are a plurality of combinations in step S3040, a separate calculation is to be performed for each combination.

When coupling three or more physical storage apparatuses 1200 with each other, if the respective physical storage apparatuses 1200 are coupled in a meshed manner, an independent calculation can be performed between the respective physical storage apparatuses 1200. When the plurality of physical storage apparatuses 1200 are coupled in a cascaded manner, a necessary IOPS is added in order to accommodate input and output which may possibly be transferred. For example, when the physical storage apparatus A and the physical storage apparatus B are mutually capable of transferring input and output and, at the same time, the physical storage apparatus B and the physical storage apparatus C are mutually capable of transferring input and output, input/output transfer performance (IOPS) that is identical or similar to input/output performance (IOPS) provided by the physical storage apparatus A must be provided for transfer from the physical storage apparatus A to the physical storage apparatus B.

In a similar manner, input/output transfer performance (IOPS) that is identical or similar to input/output performance (IOPS) provided by the physical storage apparatus C must be provided for transfer from the physical storage apparatus C to the physical storage apparatus B.

However, with respect to transfer from the physical storage apparatus B to the physical storage apparatus A, in further consideration of transfer from the physical storage apparatus C to the physical storage apparatus A via the physical storage apparatus B, a sum of the input/output performance (IOPS) provided by the physical storage apparatus C and the input/output performance (IOPS) provided by the physical storage apparatus B must be provided as input/output transfer performance (IOPS). The same description applies to transfer from the physical storage apparatus B to the physical storage apparatus C.

Finally, the CPU 1430 selects a combination of performances with a smallest amount of necessary resources among the combinations of the physical storage apparatuses 1200 satisfying the requirements.

As described above, a resource set when providing the logical partition 1600 by coupling a plurality of physical storage apparatuses 1200 with each other is calculated. In doing so, when there is no physical storage apparatus 1200 capable of independently creating the logical partition 1600, the management server 1400 calculates combinations of a plurality of physical storage apparatuses 1200 capable of providing a resource for satisfying performance for processing an input/output instruction, calculates a resource for transferring the input/output instruction with respect to the calculated combinations of the plurality of physical storage apparatuses 1200, and selects a combination of physical storage apparatuses 1200 of which a sum resource of the resource for satisfying performance for processing the input/output instruction and the resource for transferring the input/output instruction is a minimum value. Accordingly, in a case of creating the logical partition 1600 with a plurality of physical storage apparatuses 1200, when there are a plurality of possible combinations of the plurality of physical storage apparatuses 1200, since combinations of physical storage apparatuses 1200 are tentatively extracted in consideration of a resource for processing an input/output instruction and a combination requiring a minimum amount of resource is selected in consideration of a resource for transferring the input/output instruction, a combination requiring a minimum amount of resource can be readily selected.

Next, expansion of the logical partition 1600 will be described.

When the management server 1400 receives indication information which indicates expansion of a resource allocated to the logical partition 1600 provided by the physical storage apparatus 1200, the management server 1400 executes the following processes.

First, in order to expand a resource which is allocated to the logical partition 1600 and which satisfies performance for processing an input/output instruction, the management server 1400 determines whether or not the resource allocated to the logical partition 1600 can be expanded without increasing the number of physical storage apparatuses 1200 which provide a resource to the logical partition 1600. Subsequently, when the resource allocated to the logical partition 1600 can be expanded without increasing the number of physical storage apparatuses 1200 which provide a resource to the logical partition 1600, the management server 1400 issues an indication to expand the resource of the logical partition 1600 without increasing the number of physical storage apparatuses 1200 which provide a resource to the logical partition 1600. Accordingly, since the number of physical storage apparatuses 1200 which provide a resource to the logical partition 1600 is not increased when expanding the resource of the logical partition 1600, utilization efficiency of the resource can be improved.

In addition, when the number of physical storage apparatuses 1200 which provide a resource to the logical partition 1600 must be increased in order to expand the resource allocated to the logical partition 1600 and, further, when a resource for transferring an input/output instruction which is necessary for increasing the number of the physical storage apparatuses 1200 can also be provided, the management server 1400 issues an indication to the additional physical storage apparatus 1200 and to the physical storage apparatus 1200 originally providing a resource to the logical partition 1600 to expand the resource of the logical partition 1600. Accordingly, when the number of physical storage apparatuses 1200 which provide a resource to the logical partition 1600 must be increased in order to expand the logical partition 1600, since the logical partition 1600 is expanded while also securing a resource for transferring an input/output instruction which is necessary for increasing the number of the physical storage apparatuses 1200, requests for expanding the logical partition 1600 can be accepted to the greatest extent feasible while securing resources which also take the transfer of input/output instructions into consideration.

A further description will be given below.

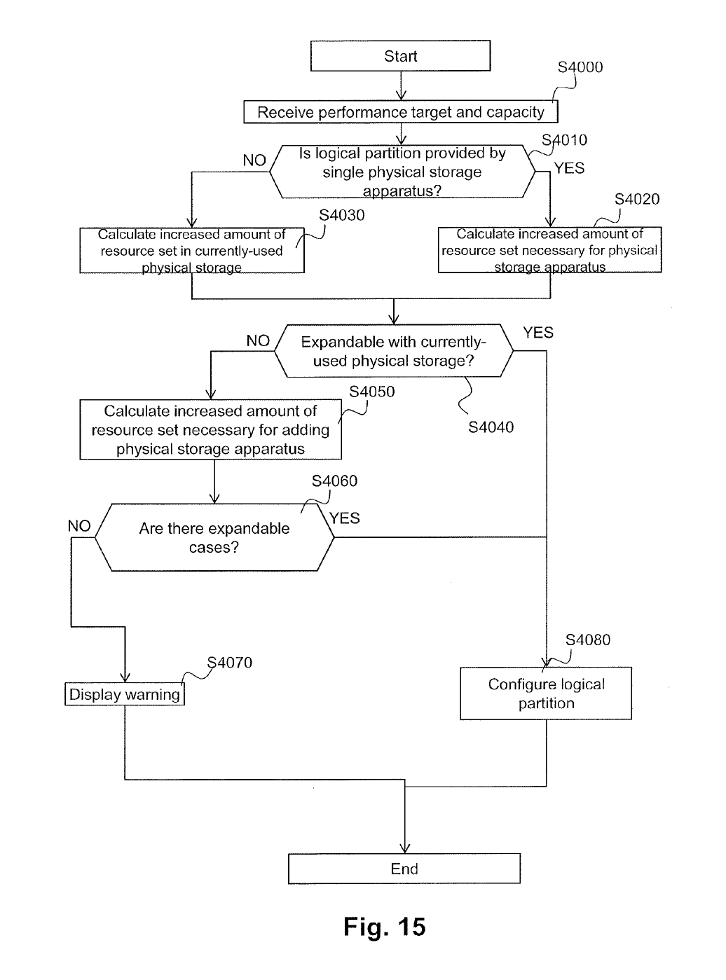

FIG. 15 is a flow chart showing a process of expanding a logical partition by the logical partition configuration program 1441.

First, the CPU 1430 receives an ID of the logical partition 1600 to be expanded and a performance target and a capacity of an amount to be expanded from the user. In addition, a performance target and a total capacity after the expansion are calculated from the performance target and the capacity of the current logical partition 1600 (S4000). Concepts of the performance target and the capacity are similar to those of step S1000.

Next, the CPU 1430 refers to the table shown in FIG. 8 and checks whether or not the logical partition 1600 to be expanded is being provided with a resource from a single physical storage apparatus 1200 (S4010). When a resource is being provided from a single physical storage apparatus 1200, the process is advanced to step S4020. Otherwise, the process is advanced to step S4030.

In step S4020, the CPU 1430 calculates a resource set necessary for expansion by the physical storage apparatus 1200 providing the logical partition 1600 to be expanded. A calculation method is similar to the method described with reference to FIG. 13. However, identification of the physical storage apparatus 1200 in step S2000 is omitted and the processes of S2020 and S2030 are only performed on the physical storage apparatus 1200 providing the logical partition 1600 to be expanded.

Meanwhile, in step S4030, the CPU 1430 calculates a resource set required by a plurality of physical storage apparatuses 1200 providing the logical partition 1600 to be expanded. A calculation method is similar to the method described with reference to FIG. 14. However, step S3000 is omitted and targets of the subsequent processes are strictly limited to the plurality of physical storage apparatuses 1200 providing the logical partition 1600 to be expanded. In addition, the combinations in step S3020 are similarly limited to combinations that use all of the plurality of physical storage apparatuses 1200 providing the logical partition 1600 to be expanded.

Furthermore, in step S4040, the CPU 1430 determines whether or not expansion of the logical partition 1600 is possible using the resource set calculated in step S4020 or step S4030. The present process is similar to the process in step S1020 or step S1040. When expansion is possible, the process is advanced to step S4080. When expansion is not possible, the process is advanced to step S4050.

In step S4050, the CPU 1430 calculates a resource set in a case where the logical partition 1600 is provided by adding other physical storage apparatuses 1200 to the one or more physical storage apparatuses 1200 providing the logical partition 1600 to be expanded. While this process is basically the same as the process shown in FIG. 14, in step S3020, combinations which include all of the one or more physical storage apparatuses 1200 providing the logical partition 1600 to be expanded and to which one or more other physical storage apparatuses 1200 have been further added are obtained.

Next, the CPU 1430 determines whether or not allocation is possible with the physical storage apparatuses 1200 to which the increased amount of the resource set calculated in step S4050 has been added (S4060). The present process is performed in a similar manner to step S1040. When allocation is not possible, the process is advanced to step S4070 in which a warning is issued to the user to the effect that expansion could not be performed, and the process is ended. On the other hand, when allocation is possible, the process is advanced to step S4080.

In step S4080, the calculated increased amount of the resource set is notified to the MP 1232 of the involved physical storage apparatuses 1200. The present process is similar to step S1060.

The logical partition 1600 is expanded as described above.

Next, contraction of the logical partition 1600 will be described.

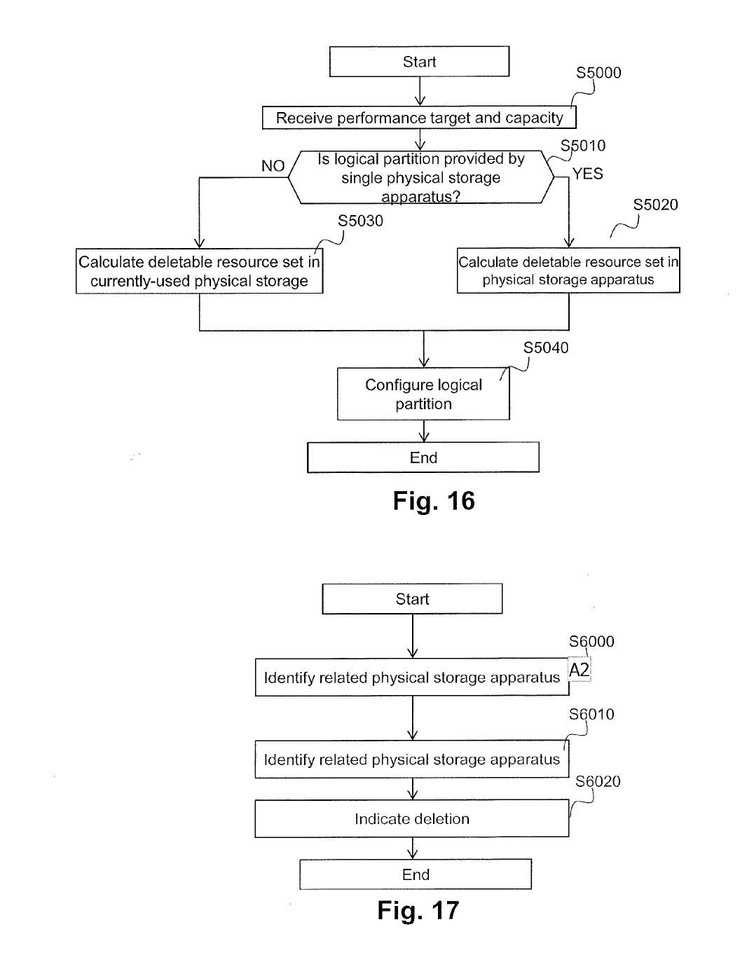

FIG. 16 is a flow chart showing a process of contracting a logical partition by the logical partition configuration program 1441.

First, the CPU 1430 receives an ID of the logical partition 1600 to be contracted and a performance target and a capacity of an amount to be contracted from the user. In addition, a performance target and a total capacity after the contraction are calculated from the performance target and the capacity of the current logical partition (S5000). Concepts of the performance target and the capacity are similar to those of step S1000.

Next, the CPU 1430 refers to the table shown in FIG. 8 in a similar manner to step S4010 and checks whether or not the logical partition 1600 to be contracted is being provided by a single physical storage apparatus 1200 (S5010). When the logical partition 1600 to be contracted is being provided by a single physical storage apparatus 1200, the process is advanced to step S5020. Otherwise, the process is advanced to step S5030.

In step S5020, the CPU 1430 calculates a resource set necessary for the contracted logical partition 1600 in the physical storage apparatus 1200 providing the logical partition 1600 to be contracted. A calculation method is similar to the method described with reference to FIG. 13. However, identification of the physical storage apparatus 1200 in step S2000 is omitted and the processes of S2020 and S2030 are only performed on the physical storage providing the logical partition 1600 to be contracted.

Meanwhile, in step S5030, the CPU 1430 calculates a resource set required by a plurality of physical storage apparatuses 1200 providing the logical partition 1600 to be contracted. A calculation method is similar to the method described with reference to FIG. 14. However, step S3000 is omitted and targets of the subsequent processes are strictly limited to the plurality of physical storage apparatuses 1200 providing the logical partition 1600 to be contracted.

Finally, the CPU 1430 selects a reduction method with highest reduction efficiency and configures a logical partition. As a reduction method, in the case of the logical partition 1600 provided by a single physical storage apparatus 1200, a method with a largest resource reduction amount is selected. In the case of the logical partition 1600 provided by a plurality of physical storage apparatuses 1200, a reduction method that enables the number of used physical storage apparatuses 1200 to be reduced is selected. Accordingly, a resource set necessary for coupling the physical storage apparatuses 1200 with each other can also be reduced.

Subsequently, a logical partition is configured in accordance with the selected method. This is similar to step S1060.

As described above, when the management server 1400 receives indication information indicating contraction of a resource allocated to the logical partition 1600 provided by the physical storage apparatus 1200, if the logical partition 1600 is provided by a plurality of physical storage apparatuses 1200, the management server 1400 issues an indication to the physical storage apparatuses 1200 to contract the resource of the logical partition 1600 so that, if possible, the number of physical storage apparatuses 1200 being straddled by the logical partition 1600 is reduced. Accordingly, if the number of physical storage apparatuses 1200 providing a resource to the logical partition 21600 can be reduced when contracting the logical partition 1600, since the logical partition 1600 is contracted so as to reduce the number of physical storage apparatuses 1200 providing a resource to the logical partition 1600, a resource necessary for transferring an input/output instruction can be minimized and utilization efficiency of the resource can be improved.

The logical partition 1600 is contracted as described above.

Next, deletion of the logical partition 1600 will be described.

FIG. 17 is a flow chart showing a process of deleting a logical partition by the logical partition configuration program 1441.

First, the CPU 1430 receives an ID of the logical partition 1600 to be deleted from the user (S6000). Next, the CPU 1430 refers to the table shown in FIG. 8 and identifies the physical storage apparatus 1200 providing the logical partition 1600 (S6010). Finally, the CPU 1430 notifies the MP 1232 of the identified physical storage apparatus 1200 of the ID of the logical partition 1600 that is a deletion target and issues an indication of deletion (S6020). This is similar to step S1060.

The logical partition 1600 is deleted as described above.

This concludes the description of example 1. Since performance can be guaranteed in the logical partition 1600 straddling physical storage apparatuses 1200 with the scheme described in the present example, even when the logical partition 1600 of which performance can be guaranteed cannot be provided by a single physical storage apparatus 1200 in the virtual storage apparatus 1500, the logical partition 1600 of which performance can be guaranteed and which is constituted by a plurality of physical storage apparatuses 1200 can be provided.

Moreover, in the description given above, a sufficient resource set is allocated using a worst-case scenario in order to transfer input and output. As another embodiment, when straddling physical storage apparatuses 1200, a certain amount of deterioration of performance may be permitted so as to reduce an amount of the resource set. For example, when an input/output process that straddles physical storage apparatuses 1200 is performed by the user when configuring the logical partition 1600, a configuration such as permitting transfer if a decline in performance is under 50% of performance requirements is accepted. In addition, when the logical partition 1600 is to straddle physical storage apparatuses 1200, a resource set capable of realizing performance equal to or higher than 50% of performance requirements is allocated. Furthermore, when logical partitions 1600 which permit deterioration of performance in this manner coexist with logical partitions 1600 which do not, an arrangement of the logical partitions 1600 is considered so that the latter logical partitions 1600 can be preferentially provided by a single physical storage apparatus 1200.

### Example 2

Example 1 describes a configuration in which transfer of input and output is performed via the FE IF 1211 for input/output transfer. In addition, when creating the logical partition 1600 straddling a plurality of physical storage apparatuses 1200, performance for transferring input and output must be realized by allocating a large amount of resource sets for guaranteeing performance. In example 2, instead of transferring input and output via the FE IF 1211 between physical storage apparatuses 1200, the BE IF 1241 is shared by a plurality of physical storage apparatuses 1200 to reduce the resource necessary for transferring input and output. In example 2, a method of creating the logical partition 1600 and the like are basically similar to those of example 1.

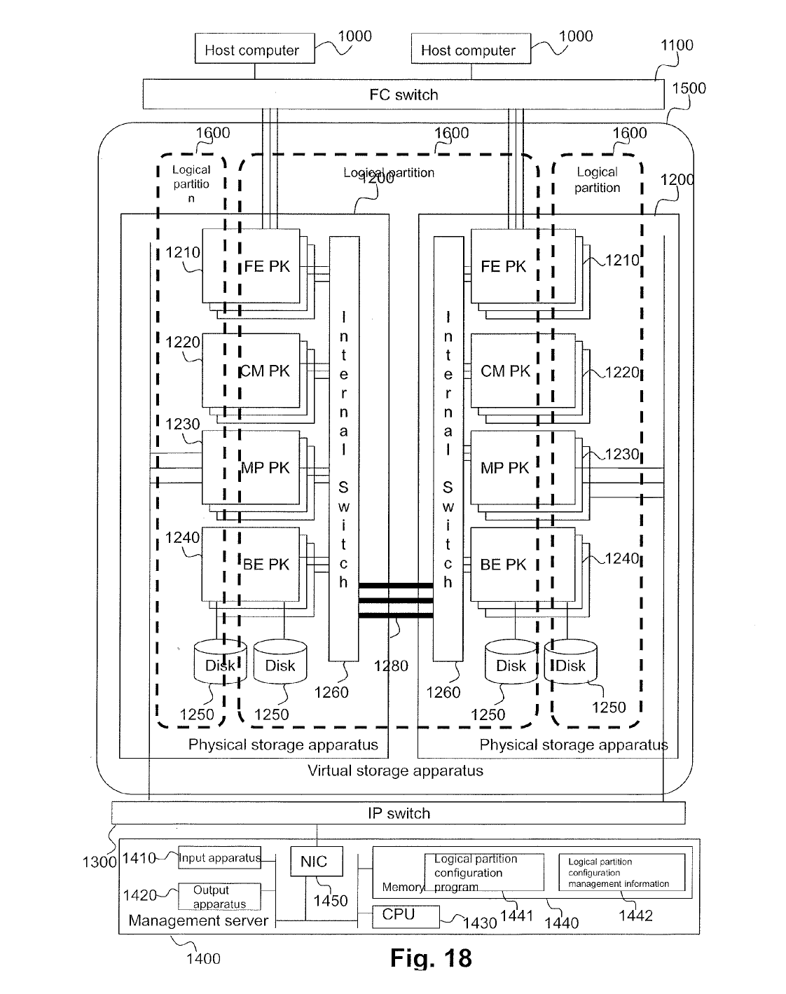

FIG. 18 is a block diagram showing a configuration example of a computer system according to example 2. While a basic configuration of the computer system according to example 2 is the same as that of the computer system according to example 1, the computer system according to example 2 differs from the computer system according to example 1 in that internal switches of the physical storage apparatuses 1200 are mutually coupled by a dedicated line 1280. In the present configuration, MPs 1232 of physical storage apparatuses 1200 belonging to the same logical partition 1600 share configuration information of a logical volume. Therefore, when the MP 1232 receives an indication of input and output with respect to a logical volume of a physical storage apparatus 1200 other than the physical storage apparatus 1200 to which the MP 1232 belongs from the host computer 1000, the MP 1232 can directly issue an indication to the BE PK 1240 of the other physical storage apparatus 1200 via the dedicated line 1280. As a result, input and output can be processed without having to use the MP 1232 and the cache memory 1221 of other outside physical storage apparatuses 1200 when transferring the input and output.

As in the present configuration, when there is a scheme for coupling a plurality of physical storage apparatuses 1200 other than the scheme of transferring input and output described in example 1, resources related to the coupling must be managed by FIG. 4 and the coupling scheme must be managed by FIG. 5 as explained in the description of example 1. In addition, since the coupling scheme according to the present configuration also involves transferring input and output, a resource set per unit performance can be managed by an expanded version of the management table shown in FIG. 7. Specifically, the dedicated line 1280 may be added to the table shown in FIG. 7 to manage usage of the dedicated line 1280. Processes similar to those of example 1 can be used to create, expand, contract, and delete the logical partition 1600.

As described above, by exchanging input and output through the dedicated line 1280 in a storage in which transfer of input and output is performed by an internal bus, a resource set necessary when creating the logical partition 1600 straddling a plurality of physical storage apparatuses 1200 can be reduced.

### Example 3

As described above, in example 2, a resource required when creating the logical partition 1600 straddling a plurality of physical storage apparatuses 1200 is reduced as compared to example 1 due to functions of the physical storage apparatuses 1200. In example 3, an amount of necessary resource is reduced by utilizing information indicating how to use the logical partition 1600.

In the present example, a state of use of each logical volume in the logical partition 1600 is monitored and, when grouping one or more logical volumes enables a load as the group to be stabilized, the group is configured as a separate logical partition. For example, by grouping two logical volumes with mutually offset load peaks, since a large load on one logical volume can be processed when a load on the other logical volume is small, peaks can be prevented from rising and loads can be stabilized.

Since a logical partition newly created by grouping is a logical partition inside a logical partition, such a logical partition will be referred to as an internal logical partition for the sake of convenience. Control by the MP 1232 with respect to an internal logical partition is identical or similar to control with respect to a logical partition.

In the present example, when logical volumes to be grouped belong to different physical storage apparatuses 1200, the logical volumes are migrated to the same physical storage apparatus 1200 so that, to the greatest extent feasible, an internal logical partition is created so as not to straddle physical storage apparatuses 1200. Accordingly, the number of input/output processes which may potentially straddle physical storage apparatuses can be reduced and, as a result, a resource set necessary for the entire logical partition 1600 can be reduced.

While a specific example will be hereinafter described with respect to example 3, since a basic configuration is similar to that of example 1, the following description will focus on differences from example 1.

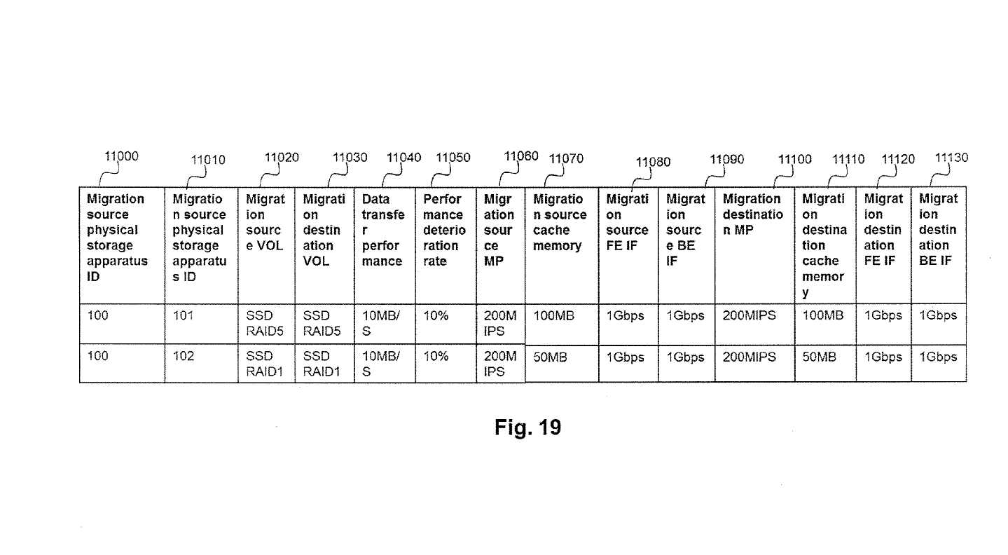

FIG. 19 is a necessary resource management table per unit performance of migration that constitutes logical partition configuration management information 1442.

The present table is a table which manages a resource set necessary for realizing unit performance of data transfer in a case where migration is performed between physical storage apparatuses 1200.

A migration source physical storage apparatus ID 11000 and a migration destination physical storage ID 11010 are IDs which uniquely identify the migration source physical storage apparatus 1200 and the migration destination physical storage apparatus 1200 of the migration. A logical volume that is a migration target of the migration source physical storage apparatus 1200 is to be migrated to the migration destination physical storage apparatus 1200.

Although a speed of data transfer during the migration is adopted as unit performance, the unit performance may also differ depending on types of a migration source logical volume and a migration destination logical volume. The types of the migration source and migration destination logical volumes are indicated in a migration source VOL 11020 and a migration destination VOL 11030. A drive type and a RAID type are stored as values.

Data transfer performance 11040 and a performance deterioration rate 11050 represent unit performance. The data transfer performance 11040 is indicated by a speed of data transfer (MB/s). The performance deterioration rate 11050 represents a deterioration rate of a response time per one input/output instruction when migration is being executed with respect to a response time when migration is not being executed.

A migration source MP 11060, a migration source cache memory 11070, a migration source FE IF 11080, and a migration source BE IF 11090 represent a resource set necessary for realizing the unit performance in the migration source physical storage apparatus 1200.

A migration destination MP 11100, a migration destination cache memory 11110, a migration destination FE IF 11120, and a migration destination BE IF 11130 represent a resource set necessary for realizing the unit performance in the migration destination physical storage apparatus 1200.

A concept of these resource sets is similar to that described with reference to FIG. 7.

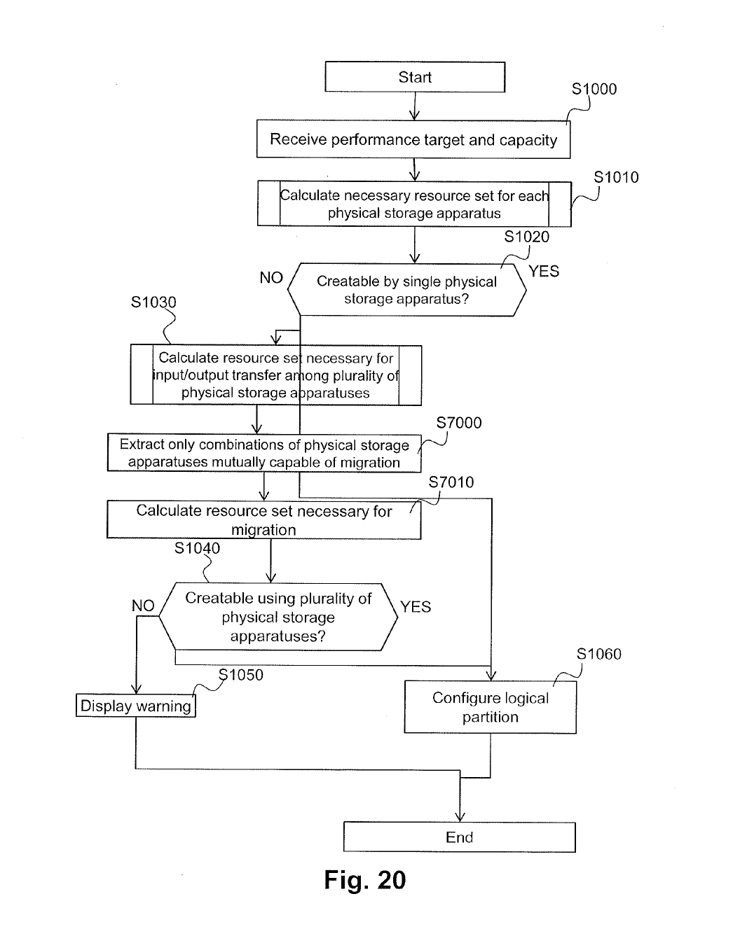

FIG. 20 is a flow chart showing a process of creating a logical partition by the logical partition configuration program 1441. A basic flow of the process of creating a logical partition according to example 3 is the same as that described in example 1.

However, when creating the logical partition 1600 straddling a plurality of physical storage apparatuses 1200, as described earlier, migration may possibly be performed when subsequently configuring an internal logical partition or the like. Therefore, combinations of the physical storage apparatuses 1200 for configuring a logical partition that straddles the physical storage apparatuses 1200 are limited to combinations of physical storage apparatuses 1200 which enable migration to be performed. In addition, for each of the physical storage apparatuses 1200, a resource set necessary for migration is calculated and secured in advance.

Step S7000 is a process of extracting only combinations of the physical storage apparatuses 1200 which enable migration. The CPU 1430 refers to the table shown in FIG. 5 to identify combinations of physical storage apparatuses 1200 which enable migration.

Step S7010 is a process of calculating a resource set for migration. The CPU 1430 refers to the table shown in FIG. 19 to identify a resource set necessary for migration for each combination of the physical storage apparatuses 1200. At this point, when there are requirements with respect to transfer performance of data during migration, a resource set is added so as to satisfy such requirements. When there are no requirements with respect to transfer performance of data, a resource set for realizing one unit performance may suffice. However, it should be noted that the time required for migration may increase when transfer performance of data is low. In addition, performance that can be realized by combinations of the respective physical storage apparatuses 1200 is calculated once again in accordance with the performance deterioration rate 11050. As a result, when there is a combination of physical storage apparatuses 1200 of which response performance no longer satisfies the requirements, the combination is eliminated.

In step S1040, a determination is made on whether or not there are sufficient resources to create the logical partition 1600 including the resource calculated in step S7010 in addition to the resource calculated in step S1030.

This concludes the description of the flow of the process of creating a logical partition according to the present example.

Moreover, expansion, contraction, and deletion of a logical partition are to be similarly processed by taking a resource set necessary for migration into consideration.

In addition, when a resource for migration is already allocated between the same physical storage apparatuses 1200 in order to realize another logical partition, the resource may be shared. However, it should be noted that processing time of migration increases in this case.

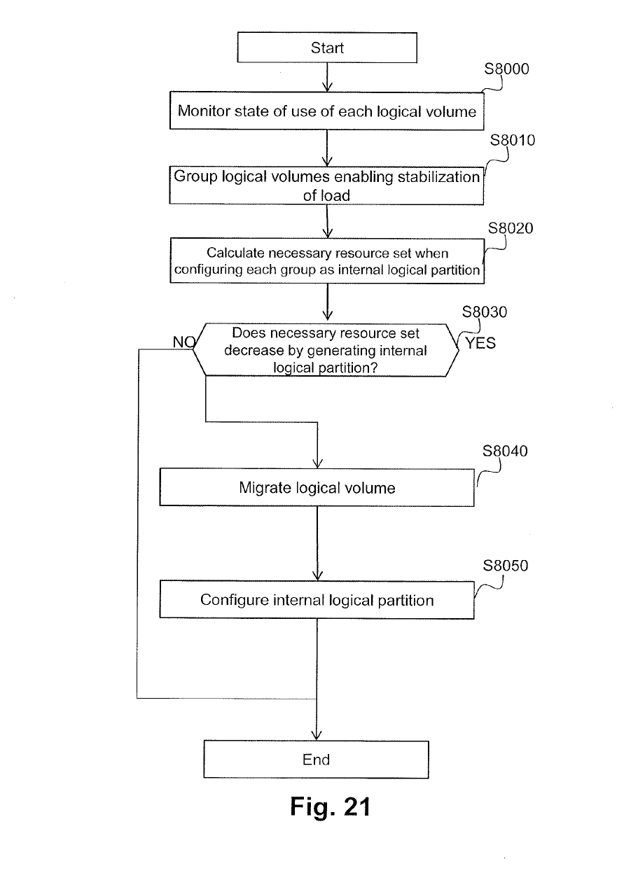

FIG. 21 is a flow chart showing a flow of a process of creating an internal logical partition by the logical partition configuration program 1441. In the present process, a resource used for each logical volume 1271 is monitored and, when there are a plurality of logical volumes 1271 which enable load to be stabilized when grouped, the logical volumes 1271 are grouped and configured as an internal logical partition.

First, the CPU 1430 monitors a load on each logical volume 1271 of the logical partition 1600 (S8000). Information to be monitored at this point is IOPS and the like.

Next, the CPU 1430 identifies a combination of one or more logical volumes 1271 of which a width of variation per time of a sum of loads thereof is smaller than a prescribed threshold (S8010). At this point, as a time period for measuring a variation width, a period may be configured in which a specific periodic pattern emerges in a variation of load of each logical volume. Generally, a period of one day or a period of one hour may be configured. In addition, the threshold of a variation width may be arbitrarily configurable by the user to, for example, a difference between a maximum value and a minimum value of the load being equal to or less than 20%, of the maximum value.

Next, the CPU 1430 respectively configures the identified combination of logical volumes 1271 and other combinations of the logical volumes 1271 as internal logical partitions and calculates a resource set of each internal logical partition (S8020).

At this point, an IOPS that is a performance requirement of an internal logical partition to which a logical volume included in the combination of logical volumes 1271 identified in step S8010 belongs is equal to a maximum value of load obtained by monitoring. As response performance, the response performance of the logical partition 1271 to which the internal logical partition belongs is inherited.

On the other hand, an IOPS that is a performance requirement of an internal logical partition to which a logical volume 1271 included in a combination of logical volumes 1271 other than the combination identified in step S8010 belongs is equal to a sum of a value obtained by subtracting a minimum load from a maximum load of an internal logical partition to which the combination of logical volumes 1271 identified in step S8010 belongs and a value obtained by subtracting a minimum load of an internal logical partition to which the combination of logical volumes 1271 identified in step S8010 belongs from performance of a logical partition to which belongs the internal logical partition to which the combination of logical volumes 1271 identified in step S8010 belongs. As response performance, the response performance of the logical partition 1271 to which the internal logical partition belongs is inherited.

A case will now be considered where, for example, when performance of a logical partition is 1000 IOPS, a maximum load of the combination of logical volumes 1271 identified in step S8010 is 200 IOPS and a minimum load thereof is 180 IOPS. The performance requirements of an internal logical partition of the combination of logical volumes 1271 identified in step S8010 include an IOPS of 200 IOPS and response performance inherited from the logical partition without modification. The performance requirements of an internal logical partition due to logical volumes other than the logical volumes identified in step S8010 include an IOPS of 820 IOPS and response performance inherited from the logical partition without modification.

A calculation method of a resource set with respect to the internal logical partitions is the same as the calculation method for a logical partition shown in FIG. 15. However, which internal logical partition is to be realized by a single physical storage apparatus 1200 is selected such that a sum of resource sets of the respective internal logical partitions is reduced.

Next, the CPU 1430 determines whether or not the calculated sum of resource sets is smaller than a resource set of the original logical partition. When the sum of resource sets is smaller than the original resource set, the process is advanced to step S8040. If not, the process is ended.

In step S8040, when the logical volumes 1271 of the internal logical partition determined not to straddle physical storage apparatuses 1200 in step S8020 belong to a plurality of physical storage apparatuses 1200, the CPU 1430 migrates the logical volumes 1271 to a single physical storage apparatus 1200.

Moreover, the physical storage apparatus 1200 that is a migration destination in this case is a physical storage apparatus 1200 capable of single-handedly providing the internal logical partition. In addition, since logical volumes are disproportionately positioned in the migration destination physical storage apparatus 1200 due to the migration, logical volumes belonging to another internal logical partition may be migrated to the migration source physical storage apparatus 1200.

Subsequently, the CPU 1430 configures the internal logical partition determined in step S8020 as a new logical partition (S8050).

This concludes the description of the process of creating an internal logical partition.

Moreover, when identifying combinations of logical volumes of an internal logical partition, the calculation of S8020 may be executed to identify a combination with a large reduction width of a resource set among all combinations without configuring a width of variation in load.

In addition, by continuing monitoring and once again executing the present process with respect to an internal logical volume straddling physical storage apparatuses 1200, a resource set can be further reduced.

Furthermore, the present process obtains logical volumes belonging to an internal logical partition and performance requirements by means of monitoring. In another example, an internal logical partition may be created based on variation information of load with respect to each logical volume 1271 which is input by the user.

As described above, when there is no physical storage apparatus 1200 capable of independently creating the logical partition 1600, the management server 1400 issues an indication to create a logical partition 1600 which straddles a plurality of physical storage apparatuses 1200 mutually capable of migration and to which a resource for satisfying performance for processing an input/output instruction, a resource for transferring an input/output instruction among the physical storage apparatuses 1200, and a resource for performing migration among the physical storage apparatuses 1200 are allocated to be created in the plurality of physical storage apparatuses 1200. Accordingly, when creating the logical partition 1600 so as to straddle a plurality of physical storage apparatuses 1200 in a system where migration is enabled among the physical storage apparatuses 1200, since a combination of physical storage apparatuses 1200 capable of migration is selected and the logical partition 1600 is created so that a resource necessary for the process of migration is secured, the logical partition 1600 straddling a plurality of physical storage apparatuses 1200 can be created so that migration can be performed.

In addition, the management server 1400 monitors respective loads of logical volumes in the logical partition 1600 provided by the physical storage apparatus 1200 and extracts a combination of a plurality of logical volumes in the logical partition 1600 which, when grouped, causes a variation in a load of input/output instructions as a group to be within a prescribed range. Furthermore, the management server 1400 calculates a resource necessary for grouping the logical volumes in the combination and, if a resource allocated to the logical partition 1600 is to be reduced based on a resource for processing an input/output instruction of the logical partition 1600 which is reduced by grouping the plurality of logical volumes and a resource necessary for grouping the plurality of logical volumes, when the plurality of logical volumes exist on different physical storage apparatuses 1600, the management server 1400 performs migration so as to place the plurality of logical volumes in the same physical storage apparatus 1200 and configures the plurality of logical volumes as an internal logical partition. Accordingly, logical volumes in the logical partition 1600 can be grouped into an internal logical partition to reduce necessary resources.

This concludes the description of a scheme for reducing a necessary amount of resources by utilizing information on how to use a logical partition.

Moreover, while the description of the present example is premised on migration and transfer of input and output, by creating an internal logical partition only when logical volumes need not be migrated, the need for a migration function can be eliminated from the physical storage apparatus 1200.

In addition, as a method of creating an internal logical partition, logical volumes with high priorities may be organized into an internal logical partition and arranged in a single physical storage apparatus 1200 while logical volumes with low priorities may be arranged as an internal logical partition that straddles physical storage apparatuses 1200. In this case, by lowering a level of guaranteed performance for logical volumes with low priorities, a resource set to be additionally allocated can be reduced. For example, when an input/output process that straddles physical storage apparatuses 1200 is performed by the user when configuring a logical partition, a configuration such as permitting a decline in performance up to 50% of performance requirements is accepted. Furthermore, when the logical partition 1600 is to straddle physical storage apparatuses 1200, a resource set capable of realizing performance equal to or higher than 50% of performance requirements is allocated.

### Example 4

In examples 1 to 3, allocation of a resource to a logical partition is performed so as to guarantee performance of an input/output process. Meanwhile, while a storage system is equipped with various functions, some functions become unusable when a logical partition straddling a plurality of physical storage apparatuses is configured. Therefore, there may be cases where a logical partition straddling physical storage apparatuses cannot be created. In example 4, a scheme which enables a logical partition to be created even when the logical partition straddles a plurality of physical storage apparatuses will be clarified from the perspective of such functions.

In the present example, a backup function will be described as an example of a function included in a storage system. The backup function is a function for creating a copy of a logical volume in a single physical storage apparatus 1200. However, when the logical partition 1600 straddles a plurality of physical storage apparatuses 1200, there may be cases where a deficiency in resources of a single physical storage apparatus 1200 occurs and a copy of a logical volume must be created in another physical storage apparatus 1200. In order to avoid such situations, when the logical partition 1600 straddles physical storage apparatuses 1200, a larger resource set is allocated to the logical partition 1600.

In example 4, a storage system is provided with a function for executing a prescribed process with respect to stored data (one example is a backup function). In addition, when there is no physical storage apparatus 1200 capable of independently creating the logical partition 1600, the management server 1400 issues an indication to create a logical partition 1600 which straddles a plurality of physical storage apparatuses 1200 and to which a resource for satisfying performance for processing an input/output instruction, a resource for transferring an input/output instruction among the physical storage apparatuses 1200, and a resource for executing the prescribed process are allocated to be created in the plurality of physical storage apparatuses 120. Accordingly, when creating the logical partition 1600 so as to straddle a plurality of physical storage apparatuses 1200 in a storage system which includes a plurality of physical storage apparatuses 1200 and which is equipped with a function for executing the prescribed process, since the logical partition 1600 is created so that a resource for executing the prescribed process is secured, the logical partition 1600 straddling a plurality of physical storage apparatuses 1200 can be created so that the prescribed process can be performed.

Furthermore, when there is no physical storage apparatus 1200 capable of independently creating the logical partition 1600, the management server 1400 issues an indication to create a logical partition 1600 which straddles a plurality of physical storage apparatuses 1200 mutually capable of performing remote copying and to which a resource for satisfying performance for processing an input/output instruction, a resource for transferring an input/output instruction among the physical storage apparatuses 1200, and a resource for executing a process of generating a copy of data are allocated to be created in the plurality of physical storage apparatuses 1200. Accordingly, when creating the logical partition 1600 so as to straddle a plurality of physical storage apparatuses 1200 in a storage system having a backup function, since the logical partition 1600 is created so that a backup of data can be secured by remote copying, the logical partition 1600 straddling a plurality of physical storage apparatuses 1200 can be created so that a backup process can be performed.

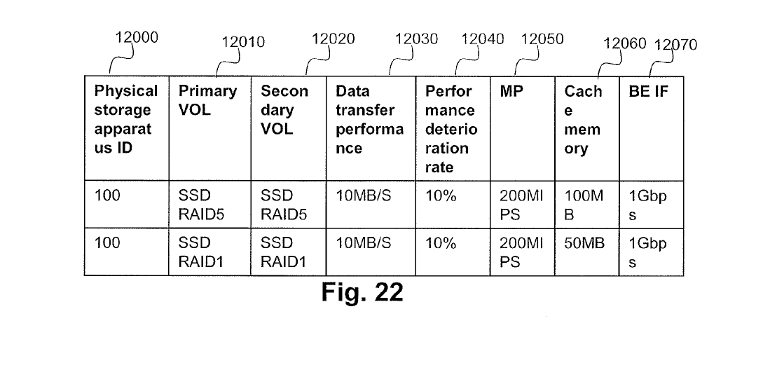

FIG. 22 is a backup resource allocation information table in the physical storage apparatus 1200 which constitutes logical partition configuration management information 1442.

A physical storage apparatus ID 12000 is an ID of the physical storage apparatus 1200 in the present computer system. A type of a logical volume to be a backup source in the physical storage apparatus 1200 is stored in a primary VOL 12010. In addition, a type of a logical volume to be a backup destination is stored in a secondary VOL 12020. Unit performance of the backup is stored in data transfer performance 12030 and a performance deterioration rate 12040.

In addition, a backup speed of the physical storage apparatus 1200 is stored in a data transfer speed 12030. A performance deterioration rate of the physical storage apparatus ID 12000 during execution of a backup is stored in 12040. A resource set necessary for realizing the unit performance is stored in an MP 12050, a cache memory 12060, and a BE IF 12070. Concepts of these values are similar to those shown in FIG. 19.

Moreover, for backups straddling physical storage apparatuses 1200, a resource set per unit performance of remote copying when performing the migration shown in FIG. 19 can be diverted.

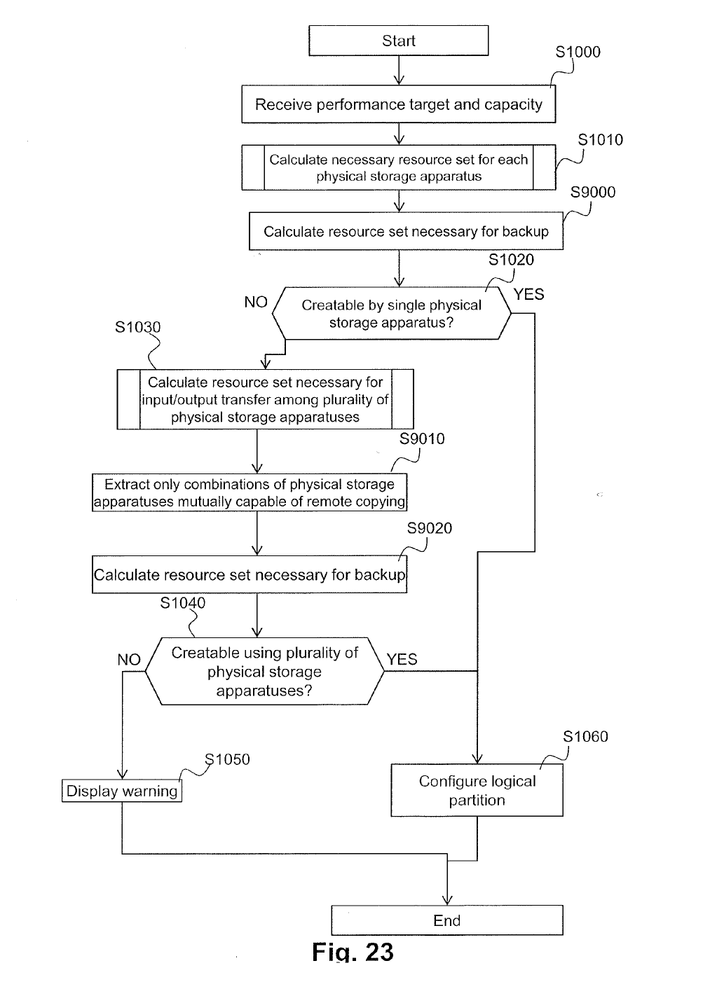

FIG. 23 is a flow chart showing a flow of a process of creating a logical partition by the logical partition configuration program 1441.

The present process is started when an indication to use a backup is issued during creation of a logical partition. A basic flow of the process is identical or similar to the flow of the process of creating a logical partition described with reference to FIG. 12. However, in step S9000, the CPU 1430 calculates a resource set necessary for backup. In this case, the CPU 1430 is to refer to the table shown in FIG. 22 and calculate a resource set capable of realizing performance in accordance with requirements from the user in each physical storage apparatus 1200. The requirements are, for example, a backup acquisition time being equal to or less than a prescribed time. Requirements related to the data transfer speed can be calculated based on a logical volume size and the backup acquisition time. The resource set is calculated based on such information.

In step S1020, the CPU 1430 determines whether or not a logical partition can be created with a single physical storage apparatus 1200 based on a sum of the resource set obtained in step S1010 and the resource set obtained in step S9000.

In step S9010, the CPU 1430 extracts a combination of the physical storage apparatuses 1200 which are mutually capable of remote copying (S9010). This is checked using the information shown in FIG. 5.

Subsequently, in step S9020, a resource set necessary for remote copying is identified using the information shown in FIG. 19. In doing so, a resource set is to be calculated in accordance with requirements by the user in a similar manner to the calculation with respect to a backup in a single physical storage apparatus 1200.

In step S1040, a determination is made on whether or not there is sufficient resource to create the logical partition 1600 including the resource calculated in step S9020 in addition to the resource calculated in step S1030.

This concludes the description of the flow of the process of creating a logical partition according to the present example.

As described above, even the logical partition 1600 including a backup function can be created so as to straddle physical storage apparatuses 1200 while maintaining functions of the logical partition 1600.

While a backup function has been described in the present example, the present example can also be applied to other functions of storage systems such as a snapshot function.

### REFERENCE SIGNS LIST

1000 Host computer
1200 Physical storage apparatus
1210 FE PK
1211 FE IF
1220 CM PK
1221 Cache memory
1230 MP PK
1231 NIC
1232 MP
1233 LM
1234 Control program
1235 Control information
1236 Logical partition information
1240 BE PK
1241 BE IF
1250 Disk drive
1260 Internal switch
1270 Group
1271 Logical volume
1280 Dedicated line
1300 IP switch
1400 Management server
1410 Input apparatus
1411 Logical partition configuration program
1420 Output apparatus
1430 CPU
1440 Memory
1441 Logical partition configuration program
1442 Logical partition configuration management information
1450 NIC
1500 Virtual storage apparatus
1600 Logical partition

1. A computer system comprising: a plurality of physical storage apparatuses; one or more host computers coupled to the physical storage apparatuses; and a management computer configured to manage the physical storage apparatuses, wherein
the physical storage apparatuses include an input/output transfer function for transferring an input/output instruction received from the host computer to another physical storage apparatus, and a logical partition control function for allocating a computer resource to one or more logical partitions, and determining which logical partition's computer resource is to be used by an input/output instruction received from the host computer, and moreover processing the input/output instruction with the logical partition's computer resource determined to be used, and
the management computer is configured to:
receive indication information which indicates creation of a logical partition and which includes information on performance for processing an input/output instruction required by the logical partition to be created;
identify a computer resource newly allocatable to a logical partition in each of the physical storage apparatuses;
determine whether or not there is a physical storage apparatus capable of independently creating a logical partition satisfying the performance for processing the input/output instruction, based on the identified computer resource allocatable to the logical partition;
issue, when there is a physical storage apparatus capable of independently creating the logical partition, to the physical storage apparatus an indication to create the logical partition to which the computer resource for satisfying performance for processing the input/output instruction is allocated; and
issue, when there is no physical storage apparatus capable of independently creating the logical partition, to the plurality of physical storage apparatuses an indication to create a logical partition which straddles a plurality of physical storage apparatuses and to which a computer resource for satisfying performance for processing the input/output instruction and a computer resource for transferring an input/output instruction among physical storage apparatuses are allocated.

2. The computer system according to claim 1, wherein
the management computer is configured to:
receive indication information that indicates expansion of a computer resource allocated to a logical partition provided by the physical storage apparatus;
determine whether or not a computer resource allocated to the logical partition can be expanded without increasing the number of physical storage apparatuses providing a computer resource to the logical partition in order to expand a computer resource which is allocated to the logical partition and which is used to satisfy performance for processing an input/output instruction; and
issue, when a computer resource allocated to the logical partition can be expanded without increasing the number of physical storage apparatuses providing a computer resource to the logical partition, an indication to expand a computer resource of the logical partition so as not to increase the number of physical storage apparatuses providing a computer resource to the logical partition.

3. The computer system according to claim 1, wherein
when the number of physical storage apparatuses providing a computer resource to the logical partition needs to be increased in order to expand a computer resource allocated to the logical partition and, further, when a computer resource for transferring an input/output instruction which is necessary for increasing the number of physical storage apparatuses can also be provided, the management computer is configured to issue an indication to the physical storage apparatuses to expand the computer resource of the logical partition.

4. The computer system according to claim 1, wherein
the management computer is configured to:
receive indication information that indicates contraction of a computer resource allocated to a logical partition provided by the physical storage apparatus; and
issue, when the logical partition is provided by a plurality of physical storage apparatuses, to the physical storage apparatuses an indication to contract the computer resource of the logical partition so that the number of physical storage apparatuses being straddled by the logical partition is reduced.

5. The computer system according to claim 1, wherein
when there is no physical storage apparatus capable of independently creating the logical partition, the management computer is configured to issue to the plurality of physical storage apparatuses an indication to create a logical partition, which straddles a plurality of physical storage apparatuses mutually capable of migration, and to which a computer resource for satisfying performance for processing the input/output instruction, a computer resource for transferring an input/output instruction among the physical storage apparatuses, and a computer resource for performing migration among the physical storage apparatuses are allocated.

6. The computer system according to claim 5, wherein
the management computer is configured to:
monitor respective loads of logical volumes in a logical partition provided by the physical storage apparatus;
extract a combination of a plurality of logical volumes in the logical partition which, when grouped, causes as a group a variation in a load of input/output instructions to be within a prescribed range;
calculate a computer resource necessary for grouping the logical volumes in the combination; and
perform, in a case where a computer resource allocated to the logical partition is to be reduced based on a computer resource for processing an input/output instruction of the logical partition which is reduced by grouping the plurality of logical volumes and a computer resource necessary for grouping the plurality of logical volumes, and when the plurality of logical volumes exist on different physical storage apparatuses, migration so as to place the plurality of logical volumes in the same physical storage apparatus and configure the plurality of logical volumes as an internal logical partition.

7. The computer system according to claim 1, comprising
a function for executing a prescribed process on stored data, wherein when there is no physical storage apparatus capable of independently creating the logical partition, the management computer is configured to issue an indication to the plurality of physical storage apparatuses to create a logical partition which straddles a plurality of physical storage apparatuses and to which a computer resource for satisfying performance for processing the input/output instruction, a computer resource for transferring an input/output instruction among physical storage apparatuses, and a computer resource for executing the prescribed process are allocated.

8. The computer system according to claim 7, wherein
the prescribed process is a process of generating a copy of data as a backup, and
when there is no physical storage apparatus capable of independently creating the logical partition, the management computer is configured to issue to the plurality of physical storage apparatuses an indication to create a logical partition which straddles a plurality of physical storage apparatuses mutually capable of remote copying and to which a computer resource for satisfying performance for processing the input/output instruction, a computer resource for transferring an input/output instruction among the physical storage apparatuses, and a computer resource for executing the process of generating a copy of data are allocated.

9. The computer system according to claim 1, wherein
when there is no physical storage apparatus capable of independently creating the logical partition, the management computer is configured to: calculate combinations of a plurality of physical storage apparatuses capable of providing a computer resource for satisfying performance for processing the input/output instruction;
calculate a computer resource for transferring an input/output instruction with respect to the calculated combinations of the plurality of physical storage apparatuses; and
select a combination of physical storage apparatuses, of which a sum computer resource of a computer resource for satisfying performance for processing the input/output instruction and a computer resource for transferring the input/output instruction is a minimum value.

10. A management computer in a computer system,
the computer system including a plurality of physical storage apparatuses and one or more host computers coupled to the physical storage apparatuses, and
the physical storage apparatuses including an input/output transfer function for transferring an input/output instruction received from the host computer to another physical storage apparatus, and a logical partition control function for allocating a computer resource to one or more logical partitions and determining which logical partition's computer resource is to be used by an input/output instruction received from the host computer, and moreover processing the input/output instruction with the logical partition's computer resource determined to be used, wherein
the management computer includes:
a memory storing logical partition configuration management information and a logical partition configuration program;
a processor which refers to the logical partition management information and executes the logical partition configuration program; and
a network interface for communicating with the physical storage apparatuses,
the logical partition configuration management information includes information for which performance for processing an input/output instruction and a computer resource necessary for the performance are associated with each other and information for which performance for transferring an input/output instruction and a computer resource necessary for the performance are associated with each other, and the management computer is configured to: by executing the logical partition configuration program with the processor,
receive indication information which indicates creation of a logical partition and which includes information on performance for processing an input/output instruction required by the logical partition to be created;
identify a computer resource newly allocatable to a logical partition in each of the physical storage apparatuses;
determine whether or not there is a physical storage apparatus capable of independently creating a logical partition satisfying the performance for processing the input/output instruction, based on the identified computer resource allocatable to the logical partition;
issue, when there is a physical storage apparatus capable of independently creating the logical partition, to the physical storage apparatus an indication to create the logical partition to which the computer resource for satisfying performance for processing the input/output instruction is allocated; and
issue, when there is no physical storage apparatus capable of independently creating the logical partition, to the plurality of physical storage apparatuses an indication to create a logical partition which straddles a plurality of physical storage apparatuses and to which a computer resource for satisfying performance for processing the input/output instruction and a computer resource for transferring an input/output instruction among physical storage apparatuses are allocated.

11. The management computer according to claim 10, which is configured to:
receive indication information that indicates expansion of a computer resource allocated to a logical partition provided by the physical storage apparatus;
determine whether or not a computer resource allocated to the logical partition can be expanded without increasing the number of physical storage apparatuses providing a computer resource to the logical partition in order to expand a computer resource which is allocated to the logical partition and which is used to satisfy performance for processing an input/output instruction; and
issue, when a computer resource allocated to the logical partition can be expanded without increasing the number of physical storage apparatuses providing a computer resource to the logical partition, an indication to expand a computer resource of the logical partition so as not to increase the number of physical storage apparatuses providing a computer resource to the logical partition.

12. A management method for a management computer to manage a physical storage apparatus in a computer system,
the computer system including a plurality of physical storage apparatuses and one or more host computers coupled to the physical storage apparatuses,
the physical storage apparatuses including an input/output transfer function for transferring an input/output instruction received from the host computer to another physical storage apparatus, and a logical partition control function for allocating a computer resource to one or more logical partitions, and determining which logical partition's computer resource is to be used by an input/output instruction received from the host computer, and moreover processing the input/output instruction with the logical partition's computer resource determined to be used,
the management computer including:
a memory storing logical partition configuration management information and a logical partition configuration program;
a processor which refers to the logical partition management information and executes the logical partition configuration program; and
a network interface for communicating with the physical storage apparatuses,
the logical partition configuration management information including information for which performance for processing an input/output instruction and a computer resource necessary for the performance are associated with each other and information for which performance for transferring an input/output instruction and a computer resource necessary for the performance are associated with each other, and the management method operating the management computer to:
by having the processor execute the logical partition configuration program,
receive indication information which indicates creation of a logical partition and which includes information on performance for processing an input/output instruction required by the logical partition to be created;
identify a computer resource newly allocatable to a logical partition in each of the physical storage apparatuses;
determine whether or not there is a physical storage apparatus capable of independently creating a logical partition satisfying the performance for processing the input/output instruction, based on the identified computer resource allocatable to the logical partition;
issue, when there is a physical storage apparatus capable of independently creating the logical partition, to the physical storage apparatus an indication to create the logical partition to which the computer resource for satisfying performance for processing the input/output instruction is allocated; and
issue, when there is no physical storage apparatus capable of independently creating the logical partition, to the plurality of physical storage apparatuses an indication to create a logical partition which straddles a plurality of physical storage apparatuses and to which a computer resource for satisfying performance for processing the input/output instruction and a computer resource for transferring an input/output instruction among physical storage apparatuses are allocated.

13. The management method according to claim 12, wherein the management method causes the management computer to:
receive indication information that indicates expansion of a computer resource allocated to a logical partition provided by the physical storage apparatus;
determine whether or not a computer resource allocated to the logical partition can be expanded without increasing the number of physical storage apparatuses providing a computer resource to the logical partition in order to expand a computer resource which is allocated to the logical partition and which is used to satisfy performance for processing an input/output instruction; and
issue, when a computer resource allocated to the logical partition can be expanded without increasing the number of physical storage apparatuses providing a computer resource to the logical partition, an indication to expand a computer resource of the logical partition so as not to increase the number of physical storage apparatuses providing a computer resource to the logical partition.
